(19) United States
(12) Patent Application Publication
(10) Pub. No.: US 2014/0071885 A1
(43) Pub. Date: Mar. 13, 2014

(54) SYSTEMS, APPARATUS, AND METHODS FOR BRIDGE LEARNING IN MULTI-HOP NETWORKS

(71) Applicant: QUALCOMM Incorporated, San Diego, CA (US)

(72) Inventors: George Cherian, San Diego, CA (US); Santosh Paul Abraham, San Diego, CA (US); Amin Jafarian, San Diego, CA (US)

(73) Assignee: QUALCOMM Incorporated, San Diego, CA (US)

(21) Appl. No.: 14/022,073

(22) Filed: Sep. 9, 2013

Related U.S. Application Data
(60) Provisional application No. 61/699,011, filed on Sep. 10, 2012.
(60) Provisional application No. 61/711,416, filed on Oct. 9, 2012.

(51) Int. Cl. H04W 40/22

(52) U.S. Cl. CPC H04W 40/22
USPC 370/315

(57) ABSTRACT

Systems, methods, and devices for communicating data in a wireless communications network are described herein. One innovative aspect of the present disclosure includes method of communicating in a multi-hop wireless mesh network comprising a root node and a plurality of relay nodes. The method includes attaching the first relay node having one or more descendant nodes. The method further includes transmitting an announcement. The method further includes maintaining, at the first relay node, a time-to-live timer for a descendant node. The method further includes updating a bridging table based on the time-to-live timer

### CROSS-REFERENCE TO RELATED APPLICATIONS

This application claims the benefit of U.S. Provisional Application No. 61/699,011, filed Sep. 10, 2012 and U.S. Provisional Application No. 61/711,416, filed Oct. 9, 2012, both of which are hereby incorporated herein by reference, in their entirety.

### BACKGROUND

1. Field

The present application relates generally to wireless communications, and more specifically to systems, methods, and devices for using a relay in a wireless communication network.

2. Background

In many telecommunication systems, communications networks are used to exchange messages among several interacting spatially-separated devices. Networks can be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/bridging technique used to interconnect the various network nodes and devices (e.g. circuit switching vs. packet switching), the type of physical media employed for transmission (e.g. wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

The devices in a wireless network can transmit/receive information between each other. In some aspects, the devices on a wireless network can have a limited transmission range. Thus, improved systems, methods, and devices for communicating in a wireless network are desired.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved communications between access points and stations in a wireless network.

One innovative aspect of the present disclosure includes a method of communicating in a multi-hop wireless mesh network including a root node and a plurality of relay nodes. The method includes attaching, at a first relay node having one or more descendant nodes, to a second relay node. The method further includes transmitting an announcement configured to initiate a modification of a routing table with respect to the attached first relay node and its descendant nodes.

In various embodiments, the method can further include determining device information for each of the descendant nodes. The method can further include transmitting the announcement can include transmitting to the root node, for each descendant node, an announcement including the device information.

In various embodiments, the announcement can include a gratuitous address resolution protocol (ARP) packet.

In various embodiments, determining the device information for each of the descendant nodes can include sending a request for device information to each descendant node and caching a response from each descendant node, the response including the device information.

In various embodiments, the request for device information can include an address resolution protocol (ARP)-Request packet. The response from each descendant node can include an ARP-Reply packet. The announcement can include a gratuitous ARP packet.

In various embodiments, determining the device information for each of the descendant nodes can include monitoring device information sent by each descendant node and caching the monitored device information for each descendant node.

In various embodiments, the monitored device information can include one or more address resolution protocol (ARP) packet. The announcement can include a gratuitous ARP packet.

In various embodiments, the method can further include associating a timer with each descendant node. The method can further include sending the request for device information to a descendant node, and relaying the response to the root node, when a packet has not been received from the descendant node before the associated timer expires. The method can further include transmitting cached device information to the root node when a packet has been received from the descendant nodes before the associated timer expires.

In various embodiments, transmitting the announcement can include transmitting, to the root node, an indication that network topology has changed.

In various embodiments, the indication that network topology has changed can include a topology change notification (TCN) bridge protocol data unit (BPDU).

In various embodiments, the wireless communications network can further include a root relay attached to the root node. The method can further include transmitting the announcement can include transmitting, to the root relay, an indication that network topology has changed.

In various embodiments, the announcement can include a topology change notification (TCN) bridge protocol data unit (BPDU).

In various embodiments, the method can further include disassociating, from a third relay node, prior to attaching to a second relay node.

In various embodiments, the announcement can include a link-layer update frame addressed to the root node, including media access control (MAC) address of all descendant nodes under the first relay. The link-layer update frame can be configured to cause each of the relay nodes, in the path between the first relay and the root node, to update a routing entry.

Another aspect provides a method of communicating in a multi-hop wireless mesh network including a root node and a plurality of relay nodes. The method includes receiving, at a first node, a notification indicating a change in a routing topology. The method further includes updating a bridging table in response to the notification.

In various embodiments, the notification can include a gratuitous address resolution protocol (ARP) packet cached by an attaching node.

In various embodiments, the first node can include the root node. The notification can include a first indication that network topology has changed. The method can further include transmitting a second indication that network topology has changed.

In various embodiments, the first indication that network topology has changed can include a topology change notification (TCN) bridge protocol data unit (BPDU). the second indication that network topology has changed can include a topology change (TC) flag in a configuration BPDU (CBPDU).

In various embodiments, the method can further include receiving a beacon from the root node. The method can further include determining if the first node is a root relay based on the beacon.

In various embodiments, the method can further include determining that the first node is a root relay when the beacon can include vendor specific information.

In various embodiments, the first node can include a root relay attached to the root node. The notification can include a first indication that network topology has changed. The method can further include transmitting a broadcast request to one or more descendant nodes of the root relay.

In various embodiments, the first indication that network topology has changed can include a topology change notification (TCN) bridge protocol data unit (BPDU). The broadcast request can include at least one of a ping packet, a discovery packet, and a keep-alive packet.

In various embodiments, the method can further include receiving a response to the broadcast request. The method can further include updating the bridging table based on the response to the broadcast request.

In various embodiments, the first node can include a root relay attached to the root node. The notification can include a first indication that network topology has changed. The method can further include transmitting a second indication that network topology has changed to one or more other root nodes.

In various embodiments, the first indication that network topology has changed can include a topology change notification (TCN) bridge protocol data unit (BPDU). The second indication that network topology has changed can include a flush-relay packet.

In various embodiments, receiving the notification can include receiving a disassociation notification from a descendant node.

In various embodiments, updating the bridging table can include flushing bridging entries for the descendant node and all the nodes under the descendant node.

Another aspect provides a method of communicating in a multi-hop wireless mesh network including a root node and a plurality of relay nodes. The method includes maintaining, at a first relay node, a time-to-live timer for a descendant node. The method further includes updating a bridging table based on the time-to-live timer.

In various embodiments, the method can further include resetting the time-to-live timer when a packet is received from the descendant node.

In various embodiments, the method can further include transmitting a request packet to the descendant node when the time-to-live timer expires.

In various embodiments, the request packet can include a least one of a ping packet, a discovery packet, and a keep-alive packet.

In various embodiments, the method can further include retransmitting the request packet when a packet is not received from the descendant node within a request timeout.

In various embodiments, the method can further include flushing entries for the descendant node, and nodes below the descendant node, when a packet is not received from the descendant node within one of the time-to-live timer, the request timeout, and a retry threshold.

Another aspect provides a device configured to communicate in a multi-hop wireless mesh network including a root node and a plurality of relay nodes. The device has one or more descendant nodes. The device includes a processor configured to attach the device to a relay node. The device further includes a transmitter configured to transmit an announcement configured to initiate a modification of a routing table with respect to the device and its descendant nodes.

In various embodiments, the processor can be further configured to determine device information for each of the descendant nodes. The transmitter can be further configured to transmit, to the root node, for each descendant node, an announcement including the device information.

In various embodiments, the announcement can include a gratuitous address resolution protocol (ARP) packet.

In various embodiments, determining the device information for each of the descendant nodes can include sending a request for device information to each descendant node and caching a response from each descendant node, the response including the device information.

In various embodiments, the request for device information can include an address resolution protocol (ARP)-Request packet. The response from each descendant node can include an ARP-Reply packet. The announcement can include a gratuitous ARP packet.

In various embodiments, determining the device information for each of the descendant nodes can include monitoring device information sent by each descendant node and caching the monitored device information for each descendant node.

In various embodiments, the monitored device information can include one or more address resolution protocol (ARP) packet. The announcement can include a gratuitous ARP packet.

In various embodiments, the processor can be further configured to associate a timer with each descendant node. The transmitter can be further configured to send the request for device information to a descendant node, and relay the response to the root node, when a packet has not been received from the descendant node before the associated timer expires. The transmitter can be further configured to transmit cached device information to the root node when a packet has been received from the descendant nodes before the associated timer expires.

In various embodiments, the transmitter can be further configured to transmit, to the root node, an indication that network topology has changed.

In various embodiments, the indication that network topology has changed can include a topology change notification (TCN) bridge protocol data unit (BPDU).

In various embodiments, the wireless communications network can further include a root relay attached to the root node. The transmitter can be further configured to transmit, to the root relay, an indication that network topology has changed.

In various embodiments, the announcement can include a topology change notification (TCN) bridge protocol data unit (BPDU).

In various embodiments, the processor can be further configured to disassociate the device, from a second relay node, prior to attaching to a relay node.

In various embodiments, the announcement can include a link-layer update frame addressed to the root node, including media access control (MAC) address of all descendant nodes under the first relay. The link-layer update frame can be configured to cause each of the relay nodes, in the path between the first relay and the root node, to update a routing entry.

Another aspect provides a device configured to communicate in a multi-hop wireless mesh network including a root node and a plurality of relay nodes. The device includes a receiver configured to receive a notification indicating a change in a routing topology. The device further includes a processor configured to update a bridging table in response to the notification.

In various embodiments, the notification can include a gratuitous address resolution protocol (ARP) packet cached by an attaching node.

In various embodiments, the first node can include the root node. The notification can include a first indication that network topology has changed. The device can further include a transmitter configured to transmit a second indication that network topology has changed.

In various embodiments, the first indication that network topology has changed can include a topology change notification (TCN) bridge protocol data unit (BPDU). The second indication that network topology has changed can include a topology change (TC) flag in a configuration BPDU (CBPDU).

In various embodiments, the receiver can be further configured to receive a beacon from the root node. The processor can be further configured to determine if the first node is a root relay based on the beacon.

In various embodiments, the processor can be further configured to determine that the first node is a root relay when the beacon can include vendor specific information.

In various embodiments, the first node can include a root relay attached to the root node. The notification can include a first indication that network topology has changed. The device can further include a transmitter configured to transmit a broadcast request to one or more descendant nodes of the root relay.

In various embodiments, the first indication that network topology has changed can include a topology change notification (TCN) bridge protocol data unit (BPDU). The broadcast request can include at least one of a ping packet, a discovery packet, and a keep-alive packet.

In various embodiments, the receiver can be further configured to receive a response to the broadcast request. The processor can be further configured to update the bridging table based on the response to the broadcast request.

In various embodiments, the first node can include a root relay attached to the root node. The notification can include a first indication that network topology has changed. The device can further include a transmitter configured to transmit a second indication that network topology has changed to one or more other root nodes.

In various embodiments, the first indication that network topology has changed can include a topology change notification (TCN) bridge protocol data unit (BPDU). The second indication that network topology has changed can include a flush-relay packet.

In various embodiments, receiving the notification can include receiving a disassociation notification from a descendant node.

In various embodiments, updating the bridging table can include flushing bridging entries for the descendant node and all the nodes under the descendant node.

Another aspect provides a device configured to communicate in a multi-hop wireless mesh network including a root node and a plurality of relay nodes. The device includes a transmitter. The device further includes a processor configured to maintain a time-to-live timer for a descendant node. The processor is further configured to update a bridging table based on the time-to-live timer.

In various embodiments, the processor can be further configured to reset the time-to-live timer when a packet is received from the descendant node.

In various embodiments, the transmitter is configured to transmit a request packet to the descendant node when the time-to-live timer expires.

In various embodiments, the request packet can include a least one of a ping packet, a discovery packet, and a keep-alive packet.

In various embodiments, the transmitter can be further configured to retransmit the request packet when a packet is not received from the descendant node within a request timeout.

In various embodiments, the processor can be further configured to flush entries for the descendant node, and nodes below the descendant node, when a packet is not received from the descendant node within one of the time-to-live timer, the request timeout, and a retry threshold.

Another aspect provides an apparatus for communicating in a multi-hop wireless mesh network including a root node and a plurality of relay nodes. The apparatus includes means for attaching, at a first relay node having one or more descendant nodes, to a second relay node. The apparatus further includes means for transmitting an announcement configured to initiate a modification of a routing table with respect to the attached first relay node and its descendant nodes.

In various embodiments, the apparatus can further include means for determining device information for each of the descendant nodes. The apparatus can further include means for transmitting the announcement can include means for transmitting to the root node, for each descendant node, an announcement including the device information.

In various embodiments, the announcement can include a gratuitous address resolution protocol (ARP) packet.

In various embodiments, means for determining the device information for each of the descendant nodes can include means for sending a request for device information to each descendant node and means for caching a response from each descendant node, the response including the device information.

In various embodiments, the request for device information can include an address resolution protocol (ARP)-Request packet. The response from each descendant node can include an ARP-Reply packet. The announcement can include a gratuitous ARP packet.

In various embodiments, means for determining the device information for each of the descendant nodes can include means for monitoring device information sent by each descendant node and means for caching the monitored device information for each descendant node.

In various embodiments, the monitored device information can include one or more address resolution protocol (ARP) packet. The announcement can include a gratuitous ARP packet.

In various embodiments, the apparatus can further include means for associating a timer with each descendant node. The apparatus can further include means for sending the request for device information to a descendant node, and means for relaying the response to the root node, when a packet has not been received from the descendant node before the associated timer expires. The apparatus can further include means for transmitting cached device information to the root node when a packet has been received from the descendant nodes before the associated timer expires.

In various embodiments, means for transmitting the announcement can include means for transmitting, to the root node, an indication that network topology has changed.

In various embodiments, the indication that network topology has changed can include a topology change notification (TCN) bridge protocol data unit (BPDU).

In various embodiments, the wireless communications network can further include a root relay attached to the root node. Means for transmitting the announcement can include means for transmitting, to the root relay, an indication that network topology has changed.

In various embodiments, the announcement can include a topology change notification (TCN) bridge protocol data unit (BPDU).

In various embodiments, the apparatus can further include means for disassociating, from a third relay node, prior to attaching to a second relay node.

In various embodiments, the announcement can include a link-layer update frame addressed to the root node, including media access control (MAC) address of all descendant nodes under the first relay, the link-layer update frame configured to cause each of the relay nodes, in the path between the first relay and the root node, to update a routing entry.

Another aspect provides an apparatus for communicating in a multi-hop wireless mesh network including a root node and a plurality of relay nodes. The apparatus includes means for receiving, at a first node, a notification indicating a change in a routing topology. The apparatus further includes means for updating a bridging table in response to the notification.

In various embodiments, the notification can include a gratuitous address resolution protocol (ARP) packet cached by an attaching node.

In various embodiments, the first node can include the root node. The notification can include a first indication that network topology has changed. The apparatus can further include means for transmitting a second indication that network topology has changed.

In various embodiments, the first indication that network topology has changed can include a topology change notification (TCN) bridge protocol data unit (BPDU). The second indication that network topology has changed can include a topology change (TC) flag in a configuration BPDU (CBPDU).

In various embodiments, the apparatus can further include means for receiving a beacon from the root node. The apparatus can further include means for determining if the first node is a root relay based on the beacon.

In various embodiments, the apparatus can further include means for determining that the first node is a root relay when the beacon can include vendor specific information.

In various embodiments, the first node can include a root relay attached to the root node. The notification can include a first indication that network topology has changed. The apparatus can further include means for transmitting a broadcast request to one or more descendant nodes of the root relay.

In various embodiments, the first indication that network topology has changed can include a topology change notification (TCN) bridge protocol data unit (BPDU). The broadcast request can include at least one of a ping packet, a discovery packet, and a keep-alive packet.

In various embodiments, the apparatus can further include means for receiving a response to the broadcast request. The apparatus can further include means for updating the bridging table based on the response to the broadcast request.

In various embodiments, the first node can include a root relay attached to the root node. The notification can include a first indication that network topology has changed. The apparatus can further include means for transmitting a second indication that network topology has changed to one or more other root nodes.

In various embodiments, the first indication that network topology has changed can include a topology change notification (TCN) bridge protocol data unit (BPDU). The second indication that network topology has changed can include a flush-relay packet.

In various embodiments, means for receiving the notification can include means for receiving a disassociation notification from a descendant node.

In various embodiments, means for updating the bridging table can include means for flushing bridging entries for the descendant node and all the nodes under the descendant node.

Another aspect provides an apparatus for communicating in a multi-hop wireless mesh network including a root node and a plurality of relay nodes. The apparatus includes means for maintaining, at a first relay node, a time-to-live timer for a descendant node. The apparatus further includes means for updating a bridging table based on the time-to-live timer.

In various embodiments, the apparatus can further include means for resetting the time-to-live timer when a packet is received from the descendant node.

In various embodiments, the apparatus can further include means for transmitting a request packet to the descendant node when the time-to-live timer expires.

In various embodiments, the request packet can include a least one of a ping packet, a discovery packet, and a keep-alive packet.

In various embodiments, the apparatus can further include means for retransmitting the request packet when a packet is not received from the descendant node within a request timeout.

In various embodiments, the apparatus can further include means for flushing entries for the descendant node, and nodes below the descendant node, when a packet is not received from the descendant node within one of the time-to-live timer, the request timeout, and a retry threshold.

Another aspect provides a non-transitory computer-readable medium. The medium includes code that, when executed, causes an apparatus to attach, at a first relay node having one or more descendant nodes, in a multi-hop wireless mesh network including a root node and a plurality of relay nodes, to a second relay node. The medium further includes code that, when executed, causes the apparatus to transmit an announcement configured to initiate a modification of a routing table with respect to the attached first relay node and its descendant nodes.

In various embodiments, the medium can further include code that, when executed, causes the apparatus to determine device information for each of the descendant nodes. The medium can further include code that, when executed, causes the apparatus to transmitting the announcement can include transmitting to the root node, for each descendant node, an announcement including the device information.

In various embodiments, the announcement can include a gratuitous address resolution protocol (ARP) packet.

In various embodiments, determining the device information for each of the descendant nodes can include sending a request for device information to each descendant node and caching a response from each descendant node, the response including the device information.

In various embodiments, the request for device information can include an address resolution protocol (ARP)-Request packet. The response from each descendant node can include an ARP-Reply packet. The announcement can include a gratuitous ARP packet.

In various embodiments, determining the device information for each of the descendant nodes can include monitoring device information sent by each descendant node and caching the monitored device information for each descendant node.

In various embodiments, the monitored device information can include one or more address resolution protocol (ARP) packet. The announcement can include a gratuitous ARP packet.

In various embodiments, the medium can further include code that, when executed, causes the apparatus to associate a timer with each descendant node. The medium can further include code that, when executed, causes the apparatus to send the request for device information to a descendant node, and relay the response to the root node, when a packet has not been received from the descendant node before the associated timer expires. The medium can further include code that, when executed, causes the apparatus to transmit cached device information to the root node when a packet has been received from the descendant nodes before the associated timer expires.

In various embodiments, transmitting the announcement can include transmitting, to the root node, an indication that network topology has changed.

In various embodiments, the indication that network topology has changed can include a topology change notification (TCN) bridge protocol data unit (BPDU).

In various embodiments, the wireless communications network can further include a root relay attached to the root node. Transmitting the announcement can include transmitting, to the root relay, an indication that network topology has changed.

In various embodiments, the announcement can include a topology change notification (TCN) bridge protocol data unit (BPDU).

In various embodiments, the medium can further include disassociating, from a third relay node, prior to attaching to a second relay node.

In various embodiments, the announcement can include a link-layer update frame addressed to the root node, including media access control (MAC) address of all descendant nodes under the first relay, the link-layer update frame configured to cause each of the relay nodes, in the path between the first relay and the root node, to update a routing entry.

Another aspect provides a non-transitory computer-readable medium. The medium includes code that, when executed, causes an apparatus to receive, at a first node in a multi-hop wireless mesh network including a root node and a plurality of relay nodes, a notification indicating a change in a routing topology. The medium further includes code that, when executed, causes the apparatus to update a bridging table in response to the notification.

In various embodiments, the notification can include a gratuitous address resolution protocol (ARP) packet cached by an attaching node.

In various embodiments, the first node can include the root node. The notification can include a first indication that network topology has changed. The medium can further include code that, when executed, causes the apparatus to transmit a second indication that network topology has changed.

In various embodiments, the first indication that network topology has changed can include a topology change notification (TCN) bridge protocol data unit (BPDU). The second indication that network topology has changed can include a topology change (TC) flag in a configuration BPDU (CBPDU).

In various embodiments, the medium can further include code that, when executed, causes the apparatus to receive a beacon from the root node. The medium can further include code that, when executed, causes the apparatus to determine if the first node is a root relay based on the beacon.

In various embodiments, the medium can further include determining that the first node is a root relay when the beacon can include vendor specific information.

In various embodiments, the first node can include a root relay attached to the root node. The notification can include a first indication that network topology has changed. The medium can further include code that, when executed, causes the apparatus to transmit a broadcast request to one or more descendant nodes of the root relay.

In various embodiments, the first indication that network topology has changed can include a topology change notification (TCN) bridge protocol data unit (BPDU). The broadcast request can include at least one of a ping packet, a discovery packet, and a keep-alive packet.

In various embodiments, the medium can further include code that, when executed, causes the apparatus to receive a response to the broadcast request. The medium can further include code that, when executed, causes the apparatus to update the bridging table based on the response to the broadcast request.

In various embodiments, the first node can include a root relay attached to the root node the notification can include a first indication that network topology has changed. The medium can further include code that, when executed, causes the apparatus to transmit a second indication that network topology has changed to one or more other root nodes.

In various embodiments, the first indication that network topology has changed can include a topology change notification (TCN) bridge protocol data unit (BPDU), and the second indication that network topology has changed can include a flush-relay packet.

In various embodiments, receiving the notification can include receiving a disassociation notification from a descendant node.

In various embodiments, updating the bridging table can include flushing bridging entries for the descendant node and all the nodes under the descendant node.

Another aspect provides a non-transitory computer-readable medium. The medium includes code that, when executed, causes an apparatus to maintain, at a first relay node in a multi-hop wireless mesh network including a root node and a plurality of relay nodes, a time-to-live timer for a descendant node. The medium further includes code that, when executed, causes the apparatus to update a bridging table based on the time-to-live timer.

In various embodiments, the medium can further include code that, when executed, causes the apparatus to reset the time-to-live timer when a packet is received from the descendant node.

In various embodiments, the medium can further include code that, when executed, causes the apparatus to transmit a request packet to the descendant node when the time-to-live timer expires.

In various embodiments, the request packet can include a least one of a ping packet, a discovery packet, and a keep-alive packet.

In various embodiments, the medium can further include code that, when executed, causes the apparatus to retransmit the request packet when a packet is not received from the descendant node within a request timeout.

In various embodiments, the medium can further include code that, when executed, causes the apparatus to flush entries for the descendant node, and nodes below the descendant node, when a packet is not received from the descendant node within one of the time-to-live timer, the request timeout, and a retry threshold.

Another aspect provides a method of communicating in a relay device including an upward station configured to associate with an access point and a downward station configured to receive an association from a wireless device. The method includes encapsulating a management frame in a data frame. The method further includes transparently exchanging individually addressed data frames between the upward station and the downward station, via an interface.

In various embodiments, the interface is configured to facilitate communication between the upward station and the downward station over a media access control (MAC) service access point (SAP).

In various embodiments, the interface can include an 802.1D bridge.

In various embodiments, the 802.1D bridge can include exactly two ports.

In various embodiments, the data frame carrying the encapsulated management frames can include action frames having an ethertype set to 89-0D.

In various embodiments, the management frame can include a reachable address message.

In various embodiments, the management frame can include an indication from the upward station to the downward station that the upward station has associated with the access point.

In various embodiments, the management frame can include an indication from the downward station to the upward station that the wireless device has associated with the downward station.

In various embodiments, the upward station is configured to send frames that have an A3 address different from an address of the upward station to the downward station via the interface.

In various embodiments, the downward station is configured to send media access control (MAC) service data unit (MSDU) frames, received from associated wireless devices, to the upward station via the interface.

Another aspect provides a relay device. The device includes an upward station configured to associate with an access point. The device further includes a downward station configured to receive an association from a wireless device. The device further includes at least one processor configured to encapsulate a management frame in a data frame. The device further includes an interface configured to transparently exchange individually addressed data frames between the upward station and the downward station.

In various embodiments, the interface can be further configured to facilitate communication between the upward station and the downward station over a media access control (MAC) service access point (SAP).

In various embodiments, the interface can include an 802.1D bridge.

In various embodiments, the 802.1D bridge can include exactly two ports.

In various embodiments, the data frame carrying the encapsulated management frames can include action frames having an ethertype set to 89-0D.

In various embodiments, the management frame can include a reachable address message.

In various embodiments, the management frame can include an indication from the upward station to the downward station that the upward station has associated with the access point.

In various embodiments, the management frame can include an indication from the downward station to the upward station that the wireless device has associated with the downward station.

In various embodiments, the upward station is configured to send frames that have an A3 address different from an address of the upward station to the downward station via the interface.

In various embodiments, the downward station is configured to send media access control (MAC) service data unit (MSDU) frames, received from associated wireless devices, to the upward station via the interface.

Another aspect provides an apparatus. The apparatus includes means for associating with an access point. The apparatus further includes means for receiving an association from a wireless device. The apparatus further includes means for encapsulating a management frame in a data frame. The apparatus further includes means for transparently exchanging individually addressed data frames between the upward station and the downward station.

In various embodiments, the method can further include means for communicating between the upward station and the downward station over a media access control (MAC) service access point (SAP).

In various embodiments, the means for transparently exchanging can include an 802.1D bridge.

In various embodiments, the 802.1D bridge can include exactly two ports.

In various embodiments, the data frame carrying the encapsulated management frames can include action frames having an ethertype set to 89-0D.

In various embodiments, the management frame can include a reachable address message.

In various embodiments, the management frame can include an indication from the means for associating to the means for receiving an association that the means for associating has associated with the access point.

In various embodiments, the management frame can include an indication from the means for receiving an association to the means for associating that the wireless device has associated with the means for receiving an association.

In various embodiments, the means for associating is configured to send frames that have an A3 address different from an address of the means for associating to the means for receiving an association via the means for transparently exchanging.

In various embodiments, the means for receiving an association is configured to send media access control (MAC) service data unit (MSDU) frames, received from associated wireless devices, to the means for associating via the means for transparently exchanging.

Another aspect provides a non-transitory computer-readable medium. The medium includes code that, when executed, causes an apparatus to encapsulate a management frame in a data frame. The medium further includes code that, when executed, causes the apparatus to transparently exchange individually addressed data frames between an upward station configured to associate with an access point and a downward station configured to receive an association from a wireless device, via an interface.

In various embodiments, the interface is configured to facilitate communication between the upward station and the downward station over a media access control (MAC) service access point (SAP).

In various embodiments, the interface can include an 802.1D bridge.

In various embodiments, the 802.1D bridge can include exactly two ports.

In various embodiments, the data frame carrying the encapsulated management frames can include action frames having an ethertype set to 89-0D.

In various embodiments, the management frame can include a reachable address message.

In various embodiments, the management frame can include an indication from the upward station to the downward station that the upward station has associated with the access point.

In various embodiments, the management frame can include an indication from the downward station to the upward station that the wireless device has associated with the downward station.

In various embodiments, the upward station is configured to send frames that have an A3 address different from an address of the upward station to the downward station via the interface.

In various embodiments, the downward station is configured to send media access control (MAC) service data unit (MSDU) frames, received from associated wireless devices, to the upward station via the interface.

### BRIEF DESCRIPTION OF THE DRAWINGS

FIG. 1 shows an exemplary wireless communication system.

FIG. 2A shows another exemplary wireless communication system in which aspects of the present disclosure can be employed.

FIG. 2B shows another exemplary wireless communication system in which aspects of the present disclosure can be employed.

FIG. 3 shows an exemplary functional block diagram of a wireless device that can be employed within the wireless communication systems of FIGS. 1, 2A, and/or 2B.

FIG. 4A illustrates a wireless communications system, according to an embodiment.

FIG. 4B illustrates a wireless communications system, according to another embodiment.

FIG. 4C is a logical diagram of a relay, according to an embodiment.

FIG. 5A illustrates a wireless communications system, according to another embodiment.

FIG. 5B illustrates a wireless communications system, according to another embodiment.

FIG. 6 is a flowchart of an exemplary method of communicating in a multi-hop wireless mesh network.

FIG. 7 is a functional block diagram of a wireless device, in accordance with an exemplary embodiment of the invention.

FIG. 8 is a flowchart of another exemplary method of communicating in a multi-hop wireless mesh network.

FIG. 9 is a functional block diagram of a wireless device, in accordance with another exemplary embodiment of the invention

FIG. 10 is a flowchart of another exemplary method of communicating in a multi-hop wireless mesh network.

FIG. 11 is a functional block diagram of a wireless device, in accordance with another exemplary embodiment of the invention.

FIG. 12 is a flowchart of an exemplary method of communicating in the relay device of FIG. 4C.

FIG. 13 is a functional block diagram of a relay device, in accordance with another exemplary embodiment of the invention

### DETAILED DESCRIPTION

Various aspects of the novel systems, apparatuses, and methods are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies can include various types of wireless local area networks (WLANs). A WLAN can be used to interconnect nearby devices together, employing widely used networking protocols. The various aspects described herein can apply to any communication standard, such as a wireless protocol.

In some aspects, wireless signals in a sub-gigahertz band can be transmitted according to the IEEE 802.11 protocol using orthogonal frequency-division multiplexing (OFDM), direct-sequence spread spectrum (DSSS) communications, a combination of OFDM and DSSS communications, or other schemes. Implementations of the IEEE 802.11 protocol can be used for sensors, metering, and smart grid networks. Advantageously, aspects of certain devices implementing the IEEE 802.11 protocol can consume less power than devices implementing other wireless protocols, and/or can be used to transmit wireless signals across a relatively long range, for example about one kilometer or longer.

In some implementations, a WLAN includes various interconnected devices, referred to as “nodes.” For example, the WLAN can include access points (“APs”) and stations (“STAs” or “clients”). In general, an AP can serve as a hub or base station for the WLAN and a STA serves as a user of the WLAN. For example, a STA can be a laptop computer, a personal digital assistant (PDA), a mobile phone, etc. In an example, a STA connects to an AP via a WI-FI™ compliant wireless link (e.g., an IEEE 802.11 protocol such as 802.11s, 802.11h, 802.11a, 802.11b, 802.11g, and/or 802.11n, etc.) to obtain general connectivity to the Internet or to other wide area networks. In some implementations a STA can also be used as an AP.

An access point (“AP”) can also include, be implemented as, or known as a gateway, a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” can also include, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal can include a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein can implement one or more of the IEEE 802.11 standards, for example. Such devices, whether used as a STA or AP or other device, can be used for smart metering or in a smart grid network. Such devices can provide sensor applications or be used in home automation. The devices can be used in a healthcare context, for example for personal healthcare. They can also be used for surveillance, to enable extended-range Internet connectivity (e.g. for use with hotspots), or to implement machine-to-machine communications.

The transmission range of wireless devices on a wireless network is of a limited distance. To accommodate the limited transmission range of devices communicating on a wireless network, access points can be positioned such that an access point is within the transmission range of the devices. In wireless networks that include devices separated by substantial geographic distance, multiple access points can be necessary to ensure all devices can communicate on the network. Including these multiple access points can add cost to the implementation of the wireless networks. Thus, a wireless network design that reduces the need for additional access points when the wireless network spans a distance that can exceed the transmission range of devices on the network can be desired.

A relay can be less expense than an access point. For example, some access point designs can include both wireless networking hardware and hardware sufficient to interface with traditional wired LAN based technologies such as Ethernet. This additional complexity can cause access points to be more expensive than relays. Additionally, because the access points can interface with a wired LAN, the cost of installing multiple access points can extend beyond the cost of the access point itself, and can include wiring costs associated with the wired LAN, and the labor and other installation costs associated with installing and configuring a wired LAN. Use of a relay instead of an access point can reduce some of the costs associated with an access point. For example, because a relay can use only wireless networking technologies, the design of the relay can provide for reduced cost when compared to access point designs. Additionally, the ability to relay wireless traffic can reduce the need for wired LAN cabling and installation expenses associated with access points.

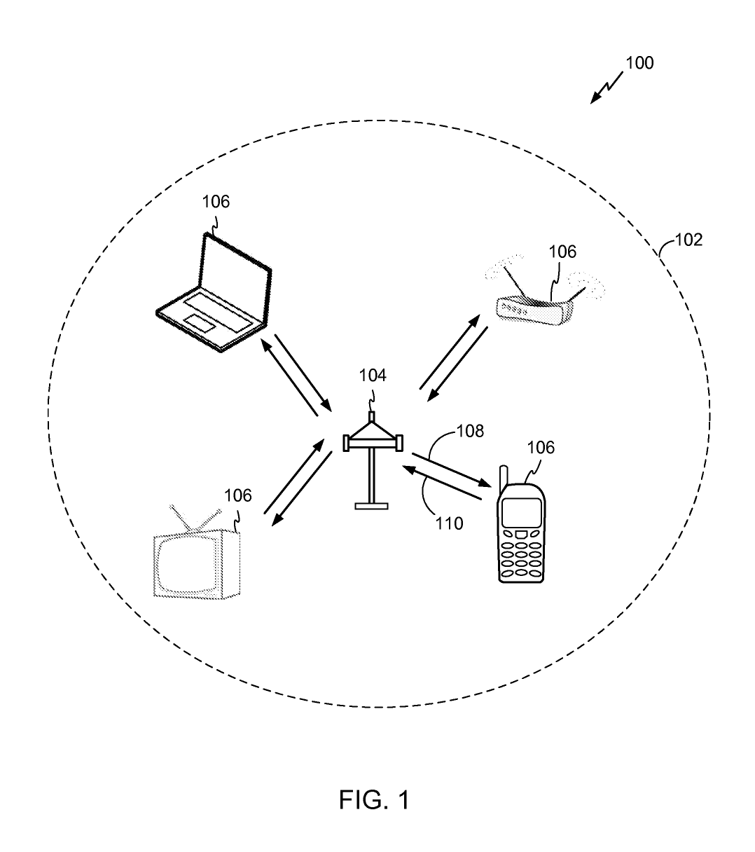

FIG. 1 shows an exemplary wireless communication system 100. The wireless communication system 100 can operate pursuant to a wireless standard, for example an 802.11 standard. The wireless communication system 100 can include an AP 104, which communicates with STAs 106.

A variety of processes and methods can be used for transmissions in the wireless communication system 100 between the AP 104 and the STAs 106. For example, signals can be sent and received between the AP 104 and the STAs 106 in accordance with orthogonal frequency-division multiplexing (“OFDM/OFDMA”) techniques. In embodiments employing OFDM/OFDMA techniques, the wireless communication system 100 can be referred to as an OFDM/OFDMA system. Alternatively, signals can be sent and received between the AP 104 and the STAs 106 in accordance with code division multiple access (“CDMA”) techniques. In embodiments employing CDMA techniques, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

The AP 104 can act as a base station and provide wireless communication coverage in a basic service area (BSA) 102. The AP 104, along with the STAs 106 associated with the AP 104, and other devices that use the AP 104 for communication, can be referred to as a basic service set (BSS). It should be noted that the wireless communication system 100 can be configured as a peer-to-peer network between the STAs 106, without a central AP 104. Accordingly, the functions of the AP 104 described herein can alternatively be performed by one or more of the STAs 106.

The AP 104 can transmit a beacon signal (or simply a “beacon”), via a communication link such as the downlink 108, to other nodes STAs 106 of the system 100, which can help the other nodes STAs 106 to synchronize their timing with the AP 104, or which can provide other information or functionality. Such beacons can be transmitted periodically. In one aspect, the period between successive transmissions can be referred to as a superframe. Transmission of a beacon can be divided into a number of groups or intervals. In one aspect, the beacon can include, but is not limited to, information such as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon can include information both common (e.g. shared) amongst several devices, and information specific to a given device.

In some aspects, a STA 106 can associate with the AP 104 and send communications to and/or receive communications from the AP 104. In one aspect, information for associating is included in a beacon broadcast by the AP 104. To receive the beacon, the STA 106 can, for example, perform a broad coverage search over a coverage region. The STA 106 can also perform a search by sweeping a coverage region in a lighthouse fashion, for example. After receiving the information for associating, the STA 106 can transmit a reference signal, such as an association probe or request, to the AP 104. In some aspects, the AP 104 can use backhaul services, for example, to communicate with a larger network, such as the Internet or a public switched telephone network (PSTN).

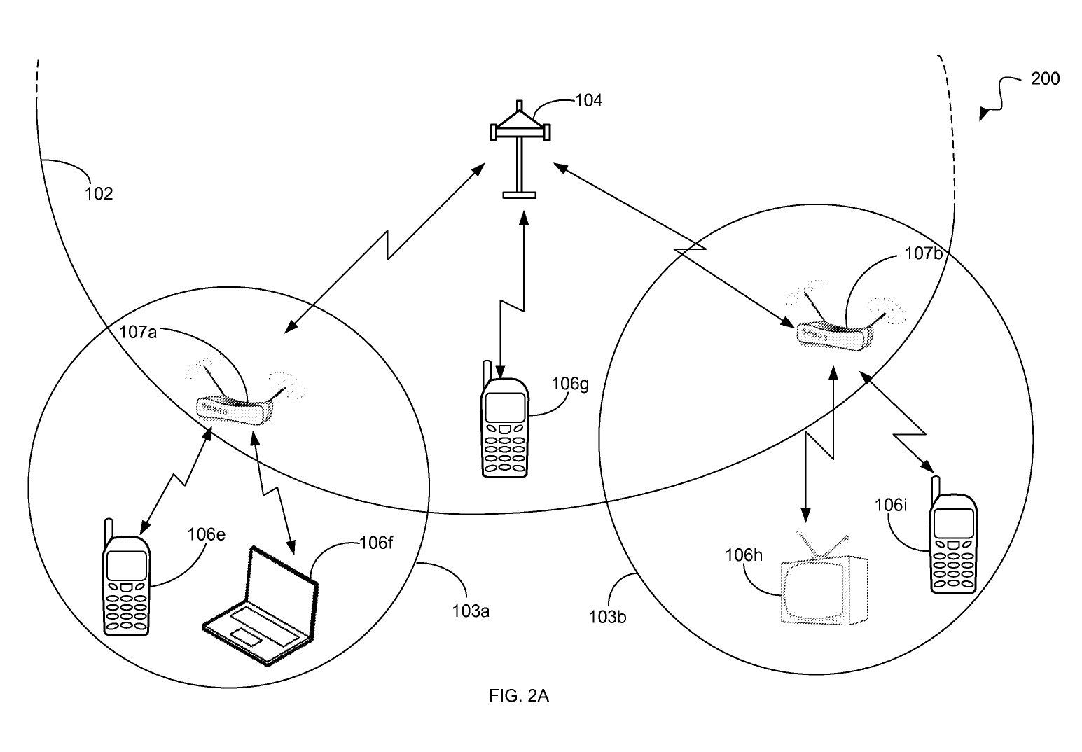

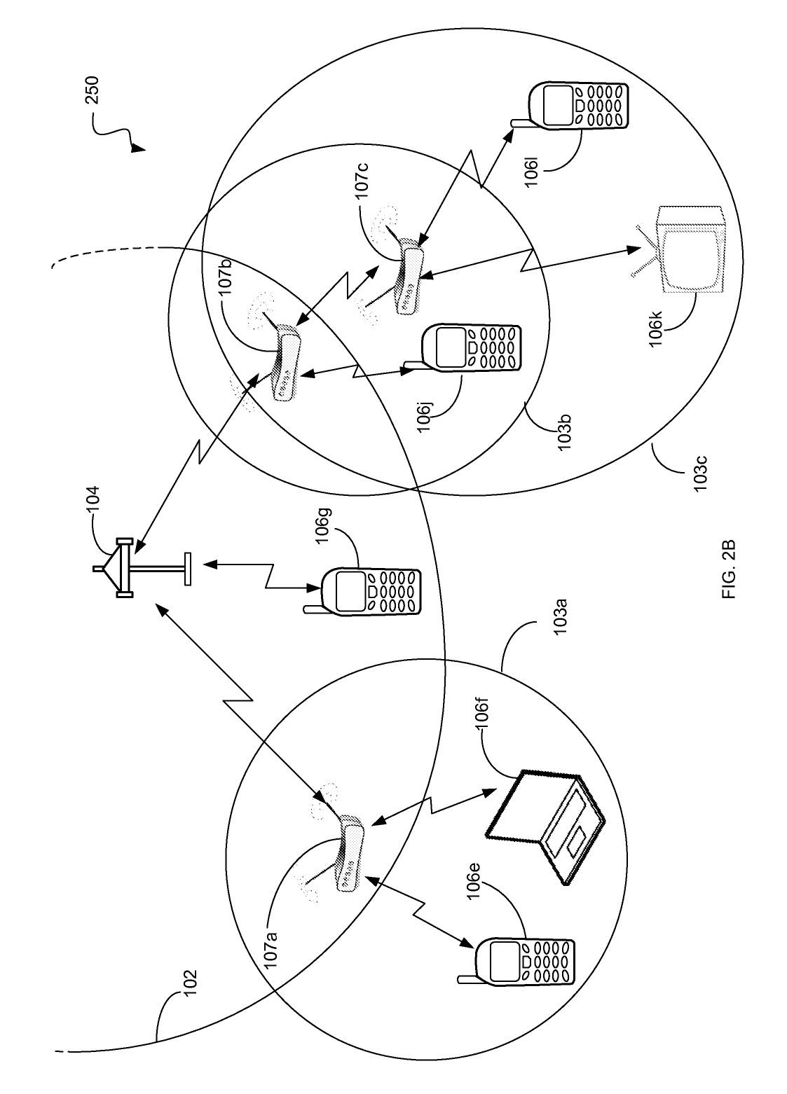

FIG. 2A shows another exemplary wireless communication system 200 in which aspects of the present disclosure can be employed. The wireless communication system 200 can also operate pursuant to a wireless standard, for example any one of the 802.11 standards. The wireless communication system 200 includes an AP 104, which communicates with relays 107a-107b and one or more STAs 106. The relays 107a-107b can also communicate with one or more STAs 106. The wireless communication system 200 can function in accordance with OFDM/OFDMA techniques and/or CDMA techniques.

The AP 104 can act as a base station and provide wireless communication coverage in the basic service area (BSA) 102. In an embodiment, one or more STAs 106 can be located within the AP's BSA 102 while other STAs can be located outside the AP's BSA 102. For example, as illustrated in FIG. 2A, STA 106g can be located within the AP 104's BSA 102. As such, STA 106g can associate with the AP 104 and perform wireless communications directly with the AP 104. Other STAs such as, for example, the STAs 106e-106f and 106h-106i can be outside the BSA 102 of the AP 104. The relays 107a-107b can be inside the BSA 102 of the AP 104. As such, the relays 107a-107b can be able to associate with the AP 104 and perform wireless communications directly with the AP 104.

The AP 104 can transmit a beacon signal (or simply a “beacon”), via a communication link such as the downlink 108, to other nodes STAs 106 of the system 200, which can help the STA 106g or the relays 107a-107b to synchronize their timing with the AP 104, or which can provide other information or functionality. Such beacons can be transmitted periodically. In one aspect, the period between successive transmissions can be referred to as a superframe. Transmission of a beacon can be divided into a number of groups or intervals. In one aspect, the beacon can include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon can include information both common (e.g. shared) amongst several devices, and information specific to a given device.

In some aspects, the STA 106g and/or the relays 107a-107b can associate with the AP 104 and send communications to and/or receive communications from the AP 104. In one aspect, information for associating is included in a beacon broadcast by the AP 104. To receive such a beacon, the STA 106g and/or the relays 107a-107b can, for example, perform a broad coverage search over a coverage region. The STAs 106 and/or the relays 107a-107b can also perform a search by sweeping a coverage region in a lighthouse fashion, for example. After receiving the information for associating, the STA 106g and/or the relays 107a-107b can transmit a reference signal, such as an association probe or request, to the AP 104. In some aspects, the AP 104 can use backhaul services, for example, to communicate with a larger network, such as the Internet or a public switched telephone network (PSTN).

The AP 104, along with the STAs 106 and/or the relays 107a-107b associated with the AP 104, and other devices that use the AP 104 for communication, can be referred to as a basic service set (BSS). It should be noted that the wireless communication system 200 can function as a peer-to-peer network between the STAs 106 and/or the relays 107a-107b, without the central AP 104. Accordingly, the functions of the AP 104 described herein can alternatively be performed by one or more of the STAs 106 and the relays 107a-107b.

The relays 107a and 107b can also act as a base station and provide wireless communication coverage in a basic service area 103a and 103b, respectively. In an embodiment, some STAs 106 can be located within the BSA of a relay 107a or 107b. For example, the STA 106e and the STA 106f are illustrated within the BSA 103a of the relay 107a. The STA 106h and the STA 106i are illustrated within the BSA 103b of the relay 107b. As such, STAs 106e-106f can associate with the relay 107a and perform wireless communications directly with the relay 107a. The relay 107a can form an association with the AP 104 and perform wireless communications with the AP 104 on behalf of the STA 106e-106f. Similarly, the STAs 106h-106i can associate with the relay 107b and perform wireless communications directly with the relay 107b. The relay 107b can form an association with the AP 104 and perform wireless communications with the AP 104 on behalf of the STA 106h-106i.

In some aspects, the STAs 106e-106f and the STAs 106h-106i can associate with the relays 107a-107b and send communications to and/or receive communications from the relays 107a-107b. In one aspect, information for associating is included in a beacon broadcast by the relays 107a-107b. The beacon signal can include the same service set identifier (SSID) as that used by an access point, such as the AP 104, with which the relay has formed an association. To receive the beacon, the STAs 106e-106f and 106h-106i can, for example, perform a broad coverage search over a coverage region. The STAs 106e-106f and 106h-106i can also perform a search by sweeping a coverage region in a lighthouse fashion, for example.

In an embodiment, after the relay 107a and/or 107b has formed an association with the AP 104 and provided a beacon signal, one or more of the STAs 106e-106i can form an association with the relay 107a and/or 107b. In an embodiment, one or more of the STAs 106e-106i can form an association with the relay 107a and/or 107b before the relay 107a and/or 107b has formed an association with the AP 104. After receiving the information for associating, the STAs 106e-106f and 106h-106i can transmit a reference signal, such as an association probe or request, to the relays 107a-107b. The relays 107a-107b can accept the association request and send an association reply to the STAs 106e-106f and 106h-106i. The STAs 106e-106f and 106h-106i can send and receive data with the relays 107a-107b. The relays 107a-107b can forward data received from the one or more STAs 106e-106f and 106h-106i to the AP 104 with which it has also formed an association. Similarly, when the relays 107a-107b receives data from the AP 104, the relays 107a-107b can forward the data received from the AP 104 to an appropriate STA 106e-106f or 106h-106i. By using the relay services of the relays 107a-107b, the STAs 106e-106f and 106h-106i can effectively communicate with the AP 104, despite being unable to directly communicate with the AP 104.

FIG. 2B shows another exemplary wireless communication system 250 in which aspects of the present disclosure can be employed. The wireless communication system 250 can also operate pursuant to a wireless standard, for example any one of the 802.11 standards. Similar to FIG. 2A, the wireless communication system 250 can include an AP 104, which communicates with wireless nodes including the relays 107a-107b and one or more STAs 106e-106g and 106j-106l. The relays 107a-107b can also communicate with wireless nodes such as some STAs 106. The wireless communication system 250 of FIG. 2B differs from the wireless communication system 200 of FIG. 2A in that the relays 107a-107b can also communicate with wireless nodes that are other relays, such as the relay 107c. As shown, the relay 107b is in communication with the relay 107c. The relay 107c can also communicate with the STAs 106k and 106l. The wireless communication system 250 can function in accordance with OFDM/OFDMA techniques or CDMA techniques.

As described above with respect to FIG. 2A, the AP 104 and relays 107a-107b can act as a base station and provide wireless communication coverage in a basic service area (BSA). As shown in FIG. 2B, the relay 107c can also act as a base station and provide wireless communication in a BSA. In the illustrated embodiment, each of the AP 104 and the relays 107a-107c cover a basic service area 102 and 103a-103c, respectively. In an embodiment, some STAs 106e-106g and 106j-106l can be located within the AP's BSA 102 while other STAs can be located outside the AP's BSA 102. For example, the STA 106g can be located within the AP 104's BSA 102. As such, the STA 106g can associate with the AP 104 and perform wireless communications directly with the AP 104. Other STAs such as, for example, the STAs 106e-106f and the STAs 106j-1 can be outside the BSA 102 of the AP 104. The relays 107a-107b can be inside the BSA 102 of the AP 104. As such, the relays 107a-107b can associate with the AP 104 and perform wireless communications directly with the AP 104.

The relay 107c can be outside the BSA 102 of the AP 104. The relay 107c can be within the BSA 103b of the relay 107b. Therefore, the relay 107c can associate with the relay 107b and perform wireless communications with the relay 107b. The relay 107b can perform wireless communications with the AP 104 on behalf of the relay 107c. The STAs 106k-106l can associate with the relay 107c. The STAs 106k-106l can perform wireless communications via indirect communication with the AP 104 and the relay 107b via communication with the relay 107c.

To communicate with the relay 107c, the STAs 106k-106l can associate with the relay 107c in a similar manner as the STAs 106e-f associate with the relay 107a, as described above. Similarly, the relay 107c can associate with the relay 107b in a similar manner as the relay 107b associates with the AP 104. Therefore, the wireless communication system 250 provides a multi-tiered topology of relays extending out from the AP 104 to provide wireless communications services beyond the BSA 102 of the AP 104. The STAs 106e-106g and 106j-106l can communicate within the wireless communication system 250 at any level of the multi-tiered topology. For example, as shown, STAs can communicate directly with the AP 104, as shown by the STA 106g. STAs can also communicate at a “first tier” of relays, for example, as shown by the STAs 106e-f and 106j which communicate with relays 107a-107b respectively. STAs can also communicate at a second tier of relays, as shown by the STAs 106k-106l, which communicate with the relay 107c.

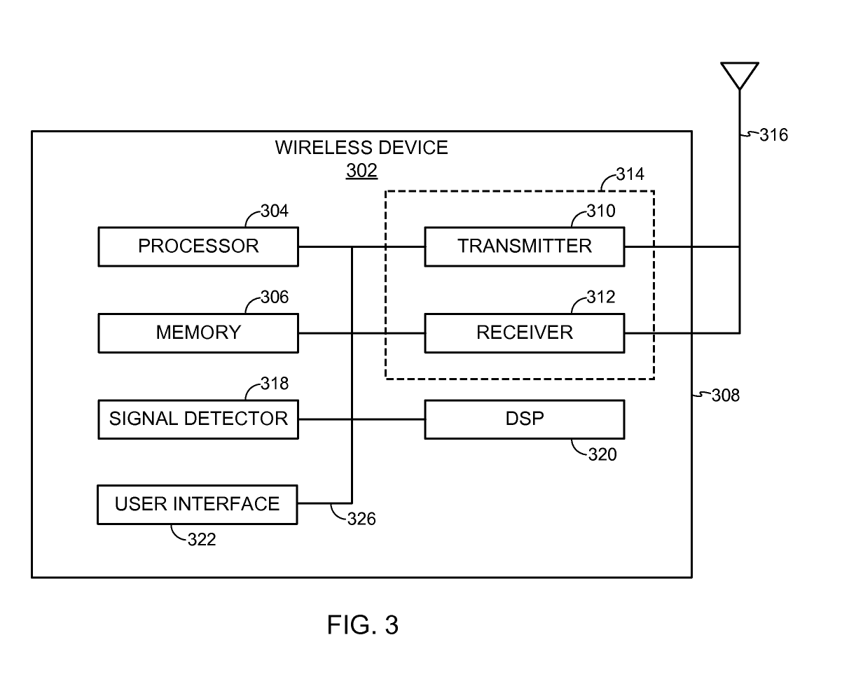

FIG. 3 shows an exemplary functional block diagram of a wireless device 302 that can be employed within the wireless communication systems 100, 200, and/or 250 of FIGS. 1, 2A, and/or 2B. The wireless device 302 is an example of a device that can be configured to implement the various methods described herein. For example, the wireless device 302 can include the AP 104, one of the STAs 106e-106l, and/or one of the relays 107a-107c.

The wireless device 302 can include a processor 304 configured to control operation of the wireless device 302. The processor 304 can also be referred to as a central processing unit (CPU). A memory 306, which can include both read-only memory (ROM) and/or random access memory (RAM), can provide instructions and data to the processor 304. A portion of the memory 306 can also include non-volatile random access memory (NVRAM). The processor 304 can perform logical and arithmetic operations based on program instructions stored within the memory 306. The instructions in the memory 306 can be executable to implement the methods described herein.

The processor 304 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 302 can also include a housing 308 that can include a transmitter 310 and/or a receiver 312 to allow transmission and reception of data between the wireless device 302 and a remote location. The transmitter 310 and receiver 312 can be combined into a transceiver 314. An antenna 316 can be attached to the housing 308 and electrically coupled to the transceiver 314. In an embodiment, the antenna 316 can be within the housing 308. In various embodiments, the wireless device 302 can also include multiple transmitters, multiple receivers, multiple transceivers, and/or multiple antennas.

The wireless device 302 can also include a signal detector 318 that can detect and quantify the level of signals received by the transceiver 314. The signal detector 318 can detect such signals as total energy, energy per subcarrier per symbol, power spectral density, and other signals. The wireless device 302 can also include a digital signal processor (DSP) 320 for use in processing signals. The DSP 320 can be configured to process packets for transmission and/or upon receipt. In some aspects, the packets can include a physical layer data unit (PPDU).

The wireless device 302 can further include a user interface 322, in some aspects. The user interface 322 can include a keypad, a microphone, a speaker, and/or a display. The user interface 322 can include any element or component that conveys information to a user of the wireless device 302 and/or receives input from the user.

The various components of the wireless device 302 can be coupled together by a bus system 326. The bus system 326 can include a data bus, for example, as well as a power bus, a control signal bus, and a status signal bus in addition to the data bus. Those of skill in the art will appreciate the components of the wireless device 302 can be coupled together or accept or provide inputs to each other using some other mechanism.

Although a number of separate components are illustrated in FIG. 3, those of skill in the art will recognize that one or more of the components can be combined or commonly implemented. For example, the processor 304 can be used to implement not only the functionality described above with respect to the processor 304, but also to implement the functionality described above with respect to the signal detector 318 and/or the DSP 320. Further, each of the components illustrated in FIG. 3 can be implemented using a plurality of separate elements.

The wireless device 302 can include an AP 104, a STA 106e-106l, or a relay 107a-107c, and can be used to transmit and/or receive communications. That is, the AP 104, the STAs 106e-106l, or the relays 107a-107c, can serve as transmitter or receiver devices. Certain aspects contemplate the signal detector 318 being used by software running on memory 306 and processor 304 to detect the presence of a transmitter or receiver.

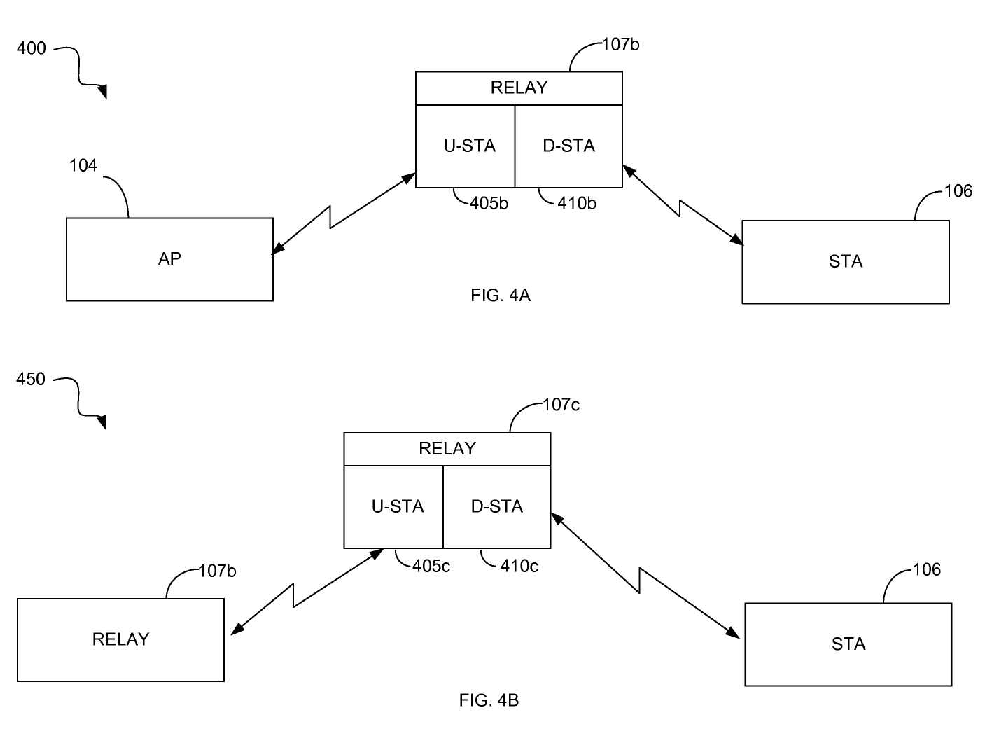

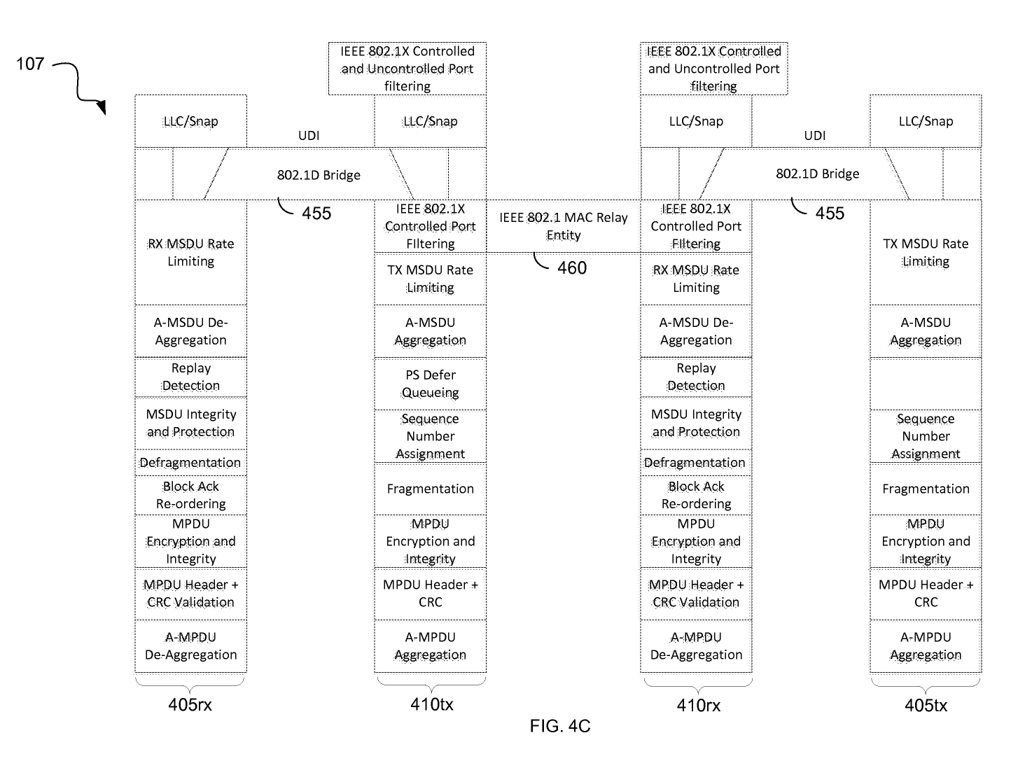

FIG. 4A illustrates a wireless communications system 400, according to an embodiment. The wireless communications system 400 includes an AP 104, a station (STA) 106, and a relay 107b. Note that while only one STA 106 and only one relay 107b are illustrated, the wireless communications system 400 can include any number of STAs and relays. In some embodiments, the AP 104 can be outside the transmission range of the STA 106. In some embodiments, the STA 106 can also be outside the transmission range of the AP 104. In these embodiments, the AP 104 and the STA 106 can communicate with the relay 107b, which can be within the transmission range of both the AP 104 and STA 106. In some embodiments, both the AP 104 and STA 106 can be within the transmission range of the relay 107b.

In the illustrated embodiment, the relay 107b includes an upward STA (U-STA) 405b and a downward STA (D-STA) 410b. In various embodiments, the U-STA 405b and the D-STA 410b can be logical entities, or can be implemented on separate physical hardware. The U-STA 405b can implement a non-AP STA having capabilities described herein, and the D-STA 410b can implement an AP having capabilities described herein. In an embodiment, the U-STA 405b and/or the D-STA 410b can be configured to support 4-address frames. For example, the U-STA 405b and/or the D-STA 410b can be capable of transmitting and/or receiving {To DS=1, From DS=1} frames.

In some implementations, the relay 107b can communicate with the AP 104, via the U-STA 405b, in the same manner as a STA would communicate with the AP. In some aspects, a relay 107b can associate with the AP 104 and send communications to and/or receive communications from the AP 104. In one aspect, information for associating is included in a beacon signal broadcast by the AP 104. To receive such a beacon, the relay 107b can, for example, perform a broad coverage search over a coverage region. The relay 107b can also perform a search by sweeping a coverage region in a lighthouse fashion, for example. After receiving the information for associating, the relay 107b can transmit a reference signal, such as an association probe or request, to the AP 104. In an embodiment, the relay 107b can utilize a first station address when exchanging network messages with the AP 104.

Similarly, the STA 106 can associate with the relay 107b, via the D-STA 410b, as if it were an AP. In some aspects, the relay 107b can implement a WI-FI DIRECT™ point-to-point group owner capability or a software-enabled access point (“SoftAP”) capability. In some aspects, the STA 106 can associate with the relay 107b and send communications to and/or receive communications from the relay 107. In one aspect, information for associating is included in a beacon broadcast by the relay 107. After receiving the information for associating, the STA 106 can transmit a reference signal, such as an association probe or request, to the relay 107b. In one embodiment, the relay 107b can utilize a second station address that is different than the first station address when exchanging network messages with one or more stations.

FIG. 4B illustrates a wireless communications system 450, according to another embodiment. The wireless communications system 450 includes a relay 107b, a relay 107c, and a station (STA) 106. Note that while only one STA 106 and only two relays 107b-107c are illustrated, the wireless communications system 450 can include any number of STAs and relays.

In the illustrated embodiment, the relay 107c includes an upward STA (U-STA) 405c and a downward STA (D-STA) 410c. In various embodiments, the U-STA 405c and the D-STA 410c can be logical entities, or can be implemented on separate physical hardware. The U-STA 405c can implement a non-AP STA having capabilities described herein, and the D-STA 410c can implement an AP having capabilities described herein. In an embodiment, the U-STA 405c and/or the D-STA 410c can be configured to support 4-address frames. For example, the U-STA 405c and/or the D-STA 410c can be capable of transmitting and/or receiving {To DS=1, From DS=1} frames.

In some implementations, the relay 107c can communicate with the AP 104, via the U-STA 405c, in the same manner as a STA would communicate with the AP. In some aspects, a relay 107c can associate with the AP 104 and send communications to and/or receive communications from the AP 104. In one aspect, information for associating is included in a beacon signal broadcast by the AP 104. To receive such a beacon, the relay 107c can, for example, perform a broad coverage search over a coverage region. The relay 107c can also perform a search by sweeping a coverage region in a lighthouse fashion, for example. After receiving the information for associating, the relay 107c can transmit a reference signal, such as an association probe or request, to the AP 104. In an embodiment, the relay 107c can utilize a first station address when exchanging network messages with the AP 104.

Similarly, the STA 106 can associate with the relay 107c, via the D-STA 410c, as if it were an AP. In some aspects, the relay 107c can implement a WI-FI DIRECT™ point-to-point group owner capability or a software-enabled access point (“SoftAP”) capability. In some aspects, the STA 106 can associate with the relay 107c and send communications to and/or receive communications from the relay 107. In one aspect, information for associating is included in a beacon broadcast by the relay 107. After receiving the information for associating, the STA 106 can transmit a reference signal, such as an association probe or request, to the relay 107c. In one embodiment, the relay 107c can utilize a second station address that is different than the first station address when exchanging network messages with one or more stations.

FIG. 4C is a logical diagram of a relay 107, according to an embodiment. In various embodiments, the relay 107 can implement one or more of the relays 107a-107c (FIGS. 2A, 2B, 4A, and 4B) and/or the wireless device 302 (FIG. 3). As shown, the relay 107 includes transmit and receive portions of the U-STA 405tx and 405rx, respectively, and transmit and receive portions of the D-STA 410tx and 410rx, respectively. In various embodiments, the U-STA 405b and/or the U-STA 405c, described above with respect to FIGS. 4A-4B, can include the transmit and receive portions of the U-STA 405tx and 405rx. Similarly, the D-STA 410b and/or the D-STA 410c, described above with respect to FIGS. 4A-4B, can include the transmit and receive portions of the D-STA 410tx and 410rx.

In the illustrated embodiment, a U-STA to D-STA interface (UDI) 455 bridges the U-STA and the D-STA. Particularly, the UDI 455 bridges the receive portion of the U-STA 405rx with the transmit portion of the D-STA 410tx, and the transmit portion of the U-STA 405tx with the receive portion of the D-STA 410tx. The transmit portion of the D-STA 410tx is connected to the receive portion of the D-STA 410rx via an IEEE 802.1 MAC relay entity 460.

The receive portion of the U-STA 405rx includes a communication stack configured to perform one or more of the following functions: aggregated MAC protocol data unit (A-MPDU) de-aggregation, MAC protocol data unit (MPDU) header and cyclic redundancy check (CRC) validation, MPDU encryption and integrity checking, block acknowledgement (ACK) reordering, defragmentation, MAC service data unit (MSDU) integrity and protection, replay detection, aggregated MSDU (A-MSDU) de-aggregation, receive (RX) MSDU rate limiting, and link layer control (LLC)/sub network access protocol (SNAP) processing. Although specific functions are described herein, a person having ordinary skill in the art will appreciate that the receive portion of the U-STA 405tx may be configured to perform additional functions, and illustrated functions may be omitted or reordered.

The transmit portion of the U-STA 405tx includes a communication stack configured to perform one or more of the following functions: aggregated MAC protocol data unit (A-MPDU) aggregation, MAC protocol data unit (MPDU) header and cyclic redundancy check (CRC) validation, MPDU encryption and integrity checking, fragmentation, sequence number assignment, aggregated MSDU (A-MSDU) aggregation, transmit (TX) MSDU rate limiting, and link layer control (LLC)/sub network access protocol (SNAP) processing. Although specific functions are described herein, a person having ordinary skill in the art will appreciate that the receive portion of the U-STA 405tx may be configured to perform additional functions, and illustrated functions may be omitted or reordered.

The receive portion of the D-STA 410rx includes a communication stack configured to perform one or more of the following functions: aggregated MAC protocol data unit (A-MPDU) de-aggregation, MAC protocol data unit (MPDU) header and cyclic redundancy check (CRC) validation, MPDU encryption and integrity checking, block acknowledgement (ACK) reordering, defragmentation, MAC service data unit (MSDU) integrity and protection, replay detection, aggregated MSDU (A-MSDU) de-aggregation, receive (RX) MSDU rate limiting, IEEE 802.1X controlled port filtering, link layer control (LLC)/sub network access protocol (SNAP) processing, and IEEE 802.1X controlled and uncontrolled port filtering. Although specific functions are described herein, a person having ordinary skill in the art will appreciate that the receive portion of the D-STA 410rx may be configured to perform additional functions, and illustrated functions may be omitted or reordered.

The transmit portion of the D-STA 410tx includes a communication stack configured to perform one or more of the following functions: aggregated MAC protocol data unit (A-MPDU) aggregation, MAC protocol data unit (MPDU) header and cyclic redundancy check (CRC) validation, MPDU encryption and integrity checking, fragmentation, sequence number assignment, PS defer queuing, aggregated MSDU (A-MSDU) aggregation, transmit (TX) MSDU rate limiting, IEEE 802.1X controlled port filtering, link layer control (LLC)/sub network access protocol (SNAP) processing, and IEEE 802.1X controlled and uncontrolled port filtering. Although specific functions are described herein, a person having ordinary skill in the art will appreciate that the receive portion of the D-STA 410tx may be configured to perform additional functions, and illustrated functions may be omitted or reordered.

The UDI bridge 455 serves to enable communication between the U-STA and the D-STA. Particularly, the UDI bridge 455 can be configured to allow the U-STA and the D-STA to exchange one or more of: an MSDU, an original source L2 address and final destination L2 address of an MSDU (e.g., A3 and A4 fields of an MPDU that carries the MSDU), an indication from the U-STA to the D-STA that the U-STA has associated with an AP and that the D-STA can start operating as an AP, and an indication from the D-STA to the U-STA that a new STA has associated with the D-STA.

For example, when the transmit portion of the U-STA 405tx processes a frame having an A3 address different from an address of the U-STA, the transmit portion of the U-STA 405tx can send the frame over the UDI 455 to the receive portion of the D-STA 410rx. Similarly, when the transmit portion of the D-STA 410tx processes a frame received from an associated STA, the transmit portion of the D-STA 410tx can send the frame over the UDI 455 to the receive portion of the U-STA 410rx. In an embodiment, the U-STA inform a parent node, via a layer 2 reachable address message, when an STA associates with the linked D-STA.

In an embodiment, the UDI 455 can include an 802.1D bridge. Particularly, the UDI 455 can include a two-port bridge. The UDI 455 can implement a transparent bridge filter for individually addressed frames. In other words, all individually addressed frames received at one port of the bridge can be automatically forwarded to the other port. In some embodiments, the UDI 455 can implement a transparent bridge filter for group addressed frames. In some embodiments, the UDI 455 can perform filtering on group addressed frames.

In some embodiments, the UDI 455 can transfer data frames, but may not transfer management frames. In an embodiment, management information between the U-STA and the D-STA can be carried using an action frame encapsulated in a data frame. The encapsulating data frame can include an ethertype set to 89-0D. For example, the encapsulating data frame can carry a management frame as a payload. The encapsulating data frame can have a payload type set to indicate that the encapsulating data frame carries a management frame as a payload. Management information can include, for example, the reachable address message, information about child nodes that associate with the D-STA, information about association of the U-STA with a parent node, etc.

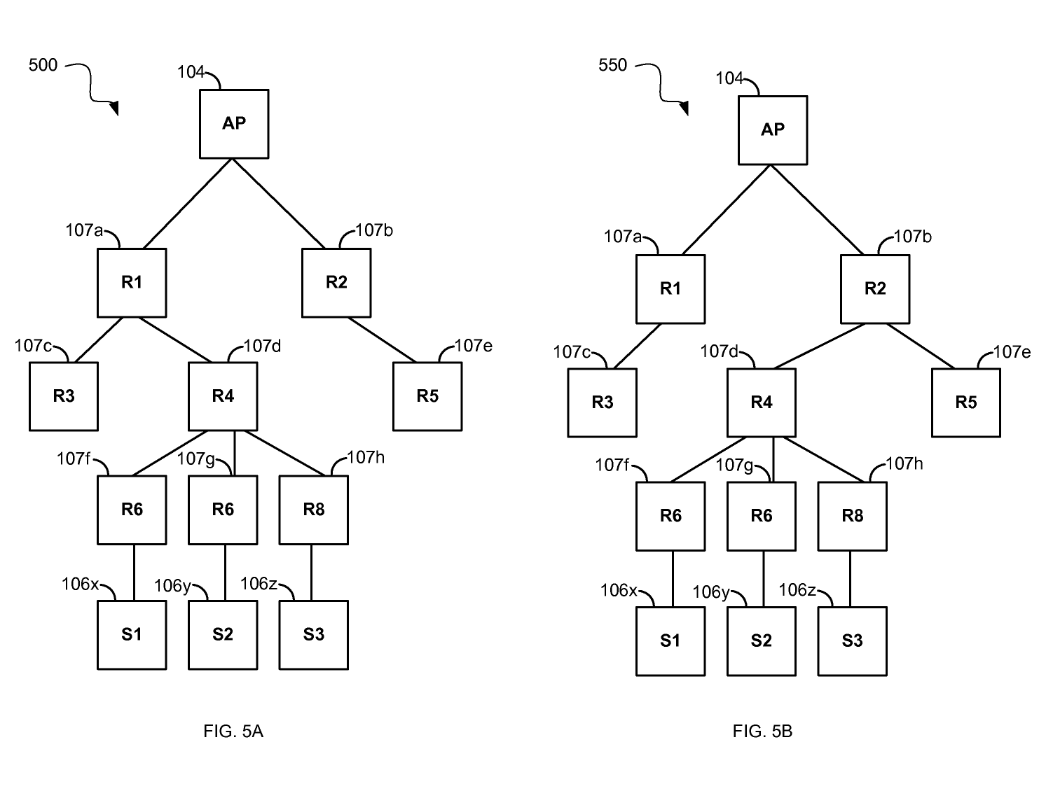

FIG. 5A illustrates a wireless communications system 500, according to another embodiment. The wireless communications system 500 includes a plurality of nodes, including the AP 104, relays 107a-107h, and STAs 106x-106z. In an embodiment, the wireless communications system 500 can be a multi-hop mesh network, as described above with respect to FIGS. 2A-B.

As shown in FIG. 5A, the STAs 106x-106z associate with the relays 107f-107h, respectively. In turn, the relays 107f-107h associate with the relay 107d. The relays 107c-107d associate with the relay 107a, and the relay 107e associates with the relay 107b. The relays 107a-107b associate with the AP 104. In various embodiments, additional APs, STAs, and/or relays (not shown) can be included in the wireless communications system 500, and some APs, STAs, and/or relays can be omitted.

In some embodiments, the AP 104 and the relays 107a-107h can build and/or maintain a bridging table, or bridging information base (RIB), including bridging information for one or more of the nodes in the wireless communications system 500. The bridging table can facilitate relay of information between each node in the wireless communications system 500. The bridging table can be stored, for example, in the memory 306 (FIG. 3). In various embodiments, the bridging table can be referred to as a “routing table.”

The bridging table can include destination node information, such as a media access control (MAC) address of one or more nodes, associated with bridging information, such as the MAC address of the next hop to reach the destination node. In various embodiments, the bridging table can include one or more of a destination network identifier, a cost or metric of a path to the destination node, a network identifier of the next node to which information should be sent to reach the destination node, a quality of service associated with a route, filtering criteria, and access lists associated with a route.

For example, the relay 107e can have a packet for the STA 106x. The relay 107e can look up the MAC address of the STA 106x in its bridging table, determine that the next hop is the relay 107b, and transmit the packet to the relay 107b. The relay 107b can look up the MAC address of the STA 106x in its bridging table, determine that the next hop is the AP 104, and transmit the packet to the AP 104. The AP 104 can look up the MAC address of the STA 106x in its bridging table, determine that the next hop is the relay 107a, and transmit the packet to the relay 107a. The relay 107a can look up the MAC address of the STA 106x in its bridging table, determine that the next hop is the relay 107d, and transmit the packet to the relay 107d. The relay 107d can look up the MAC address of the STA 106x in its bridging table, determine that the next hop is the relay 107f, and transmit the packet to the relay 107f. The relay 107f can look up the MAC address of the STA 106x in its bridging table, determine that the next hop is the STA 106x, and transmit the packet to the STA 106x.

In various embodiments, the wireless communications system 500 can be reconfigured over time. For example, one or more STAs 106x-106z can disassociate from the relays 107a-107h. The STAs 106x-106z, or other STAs (not shown), can associate with different relays 107a-107h, or the AP 104. The relays 107a-107h can disassociate from their respective relays 107a-107h, or the AP 104. The relays 107a-107h, or other relays (not shown), can associate with different relays 107a-107h, or the AP 104.

Each node that associates with another node can be referred to as a “child” of that “parent” node. Children of a parent, and successive children of the children, can be referred to as “descendant” nodes. Parents of a child, and successive parents of the parent, can be referred to as “ancestor” nodes. Nodes with no parents can be referred to as “root” nodes. Nodes with no children can be referred to as “leaf” nodes. As shown in FIG. 5A, the AP 104 is a root node, and the relays 107c and 107e, and the STAs 106x-106z, are leaf nodes. Nodes with both parent nodes and child nodes can be referred to as intermediate nodes. As shown in FIG. 5A, the relays 107a-107b, 107d, and 107f-107h are intermediate nodes.

When an intermediate node associates, or attaches, to a different parent node, the intermediate node brings its descendants with it. When attaching to a different parent node, the intermediate node may not notify the old parent node in advance. Accordingly, the old parent node, and the nodes above the old parent node, can have a bridging table that has out-of-date or “stale” information with respect to the intermediate node and its descendants. Similarly, the new parent node, and the nodes above it, can have stale bridging tables with respect to the intermediate node and its descendants. The old parent node, and the nodes above the old parent node, can be referred to herein as an “old branch.” The new parent node, and the nodes above the new parent node, can be referred to herein as a “new branch.” When the intermediate relay node moves and attaches to a new parent relay node, then the new parent relay node, and its ancestors, can lack information about the intermediate relay node and its descendants in order to route down-link packets to the intermediate relay node and its descendants.

FIG. 5B illustrates a wireless communications system 550, according to another embodiment. The wireless communications system 550 is similar to the wireless communications system 500 of FIG. 5A, but differs in that the relay 107d has detached from the relay 107a, and attached to the relay 107b. The wireless communications system 550 includes the AP 104, the relays 107a-107h, and the STAs 106x-106z. In an embodiment, the wireless communications system 550 can be a multi-hop mesh network, as described above with respect to FIGS. 2A-B.

In an embodiment, the nodes in the old branch (i.e., the relay 107a and the AP 104) have stale bridging tables with respect to the relays 107d and 107f-107h, and the STAs 106x-106z, because they are not yet aware that the relay 107d is no longer connected to the relay 107a. Similarly, the nodes in the new branch (i.e., the relay 107b and the AP 104) have stale bridging tables with respect to the relays 107d and 107f-107h, and the STAs 106x-106z, because they are not yet aware that the relay 107d is connected to the relay 107b. In some embodiments, the new parent node (i.e., the relay 107b) is aware that the relay 107d is connected, but has not yet updated its bridging table. Accordingly, information addressed to any of the relays 107d and 107f-107h, and the STAs 106x-106z can be misrouted.

For example, the relay 107e can have a packet for the STA 106x. The relay 107e can look up the MAC address of the STA 106x in its bridging table, correctly determine that the next hop is the relay 107b, and transmit the packet to the relay 107b. The relay 107b can look up the MAC address of the STA 106x in its stale bridging table, incorrectly determine that the next hop is the AP 104, and transmit the packet to the AP 104. The AP 104 can look up the MAC address of the STA 106x in its stale bridging table, incorrectly determine that the next hop is the relay 107a, and transmit the packet to the relay 107a. The relay 107a can look up the MAC address of the STA 106x in its stale bridging table, incorrectly determine that the next hop is the relay 107d, and attempt to transmit the packet to the relay 107d. Because the relay 107d is no longer in direct communication with the delay 107a, the relay 107a will not be able to transmit the packet.

Various techniques described herein can enable nodes in a new branch to learn the routing of packets to the nodes under a newly associated relay, and can enable nodes in an old branch to flush the routing information of the nodes under a recently disassociated relay. For example, with respect to FIG. 5B, the techniques described herein can enable the relays 107a and 107b, and/or the AP 104, to flush their bridging tables with respect to the relays 107d and 107f-107h, and the STAs 106x-106z. Similarly, the techniques described herein can enable the relays 107a and 107b, and/or the AP 104, to update their bridging tables with respect to the relays 107d and 107f-107h, and the STAs 106x-106z. In one embodiment, before the relay node 107d reattaches to a new relay node 107b, it can disassociate with its previous parent 107a, and provide a token. The previous parent 107a can propagate the disassociation request up the chain all the way to the root AP 104. When the relay node 107d attaches to the new parent 107b, the association request can include the same token. The relay node 107d can send a link-layer update frame or an existing frame (e.g., an action frame) that carries a new information element to the parent node 107b which is further propagated up the chain to the root AP 104, that includes all the addresses of the descendent nodes 107f-107h and 106x-106z under the relay 107d. All the relay nodes in the path to the root AP 104 can monitor the link-layer update frame, and, and can update their bridging tables accordingly.

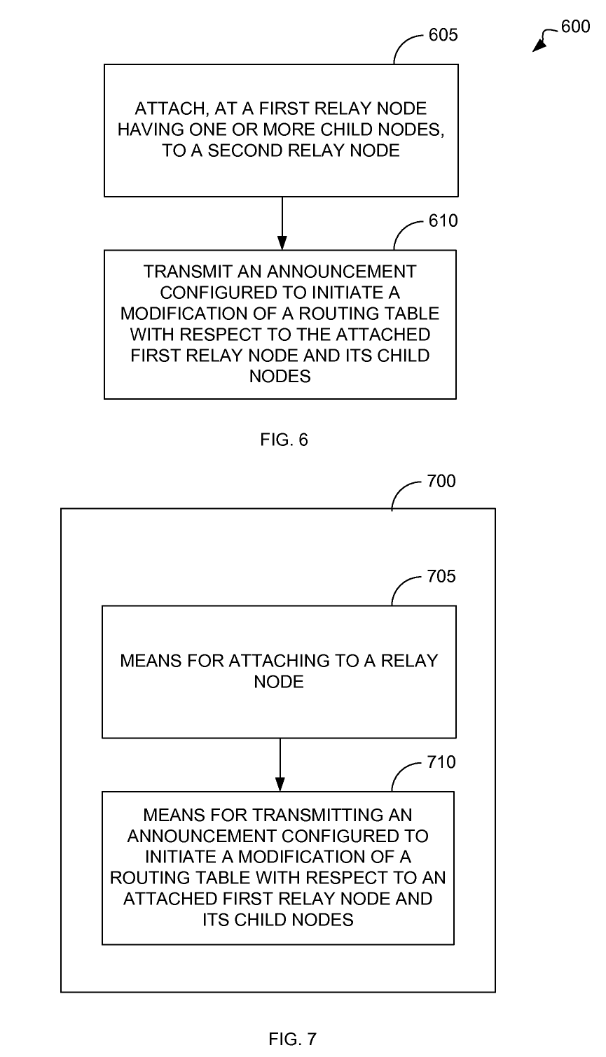

FIG. 6 is a flowchart 600 of an exemplary method of communicating in a multi-hop wireless mesh network. For example, the method of the flowchart 600 can be implemented within the wireless communication system 200, 250, 400, 450, 500, and/or 550, described above with respect to FIGS. 2A, 2B, 4A, 4B, 5A, and 5B, respectively. Particularly, the method of the flowchart 600 can be implemented by one or more of the AP 104 and the relays 107a-h. Although the method of the flowchart 600 is described herein with particular reference to the wireless device 302, discussed above with respect to FIG. 3, a person having ordinary skill in the art will appreciate that the method of flowchart 600 can be implemented by any other suitable device. In an embodiment, the steps in the flowchart 600 can be performed by a processor or controller, such as the processor 304 or the DSP 320 in conjunction with one or more of the memory 306, the transmitter 310, and the receiver 312, described above with respect to FIG. 3. Although the method of the flowchart 600 is described herein with reference to a particular order, in various embodiments, blocks herein can be performed in a different order, or omitted, and additional blocks can be added.

First, at block 605, a first relay node attaches to a second relay node. The first relay node can have one or more descendant nodes. For example, as shown in FIG. 5B, the relay 107d can attach to the relay 107b. The relay 107d has descendant nodes 107f-107h and 106x-106z. In an embodiment where the wireless device 302 is configured as the relay 107d, the processor 304 can cause the transmitter 310 to send an association message to the relay 107b.

Next, at block 610, the first relay node transmits an announcement. The announcement can serve to indicate to other nodes that network topology has changed. Particularly, the announcement can be configured to initiate a modification of a routing table with respect to the attached first relay node and its descendant nodes. In various embodiments, the announcement can include an address resolution protocol (ARP) packet, a topology change notification (TCN) bridge protocol data unit (BPDU), and/or another message indicative of network topology. In response to the announcement, one or more nodes can update their bridging tables, and/or generate additional messages indicative of network topology.

### Re-Configuration of Bridging Table Using Gratuitous ARP

In various embodiments, the first node can determine device information for one or more descendant nodes. In an embodiment, the first node can determine device information for each descendant node. In various embodiments, device information can include, for example, a MAC address, an Internet protocol (IP) address, and/or other identifying information. The first node can determine the device information before attaching to the second node. The announcement can include the device information.

In an embodiment, the announcement can include a gratuitous ARP packet containing device information for a descendant node. Gratuitous ARP packets can serve to update the bridging tables of one or more nodes in the wireless communication system 550. The gratuitous ARP packet can include an IP address and/or MAC address of a descendant node. In an embodiment, the first node broadcasts the gratuitous ARP. In an embodiment, the first node transmits the gratuitous ARP to the root node. In various embodiments, the first node transmits the gratuitous ARP for each descendant node. In various embodiments, the ARP packets discussed herein can be sent and received in accordance with Internet Standard STD 37.

In one embodiment, the first node requests device information from at least one descendant node. In an embodiment, the first node requests device information from each descendant node. The first node can cache a response from each descendant node including the requested device information. The first node can replay, repeat, or relay the responses after attaching to the second node.

For example, with reference to FIG. 5B, the relay 107d sends an ARP-Request packet to each descendant node 107f-107h and 106x-106z. The relay 107d can send the ARP-Request before or after attaching to the relay 107b. The descendant nodes 107f-107h and 106x-106z can respond with an ARP-Reply packet, including node information such as MAC address and/or IP address. In embodiments where the relay 107d sends the ARP-Request after attaching to the relay 107b, the relay 107d can convert the ARP-Reply packets into gratuitous ARP packets. The relay 107d can generate the gratuitous ARP packets so they appear to be generated by the descendant nodes 107f-107h and 106x-106z. The relay 107d can transmit the gratuitous ARP packets to the AP 104.

In embodiments where the relay 107d sends the ARP-Request before attaching to the relay 107b, the relay 107d can cache the responses, for example in the memory 306 (FIG. 3). After attaching to the relay 107b, the relay 107d can generate gratuitous ARP packets based on the cached ARP-Reply packets. The relay 107d can generate the gratuitous ARP packets so that they appear to be generated by the descendant nodes 107f-107h and 106x-106z. The relay 107d can transmit the gratuitous ARP packets to the AP 104.

In another embodiment, the first node can monitor device information sent by descendant nodes. The first node can cache the monitored device information, for example, for each descendant node. For example, with reference to FIG. 5B, the relay 107d can maintain an ARP cache, such as in the memory 306 (FIG. 3). The relay 107d can update the ARP cache when it receives a gratuitous ARP. In an embodiment, the relay 107d can update the ARP cache only when it sees a gratuitous ARP from one of its descendants (i.e., the relays 107f-107h and the STAs 106x-106z). After attaching to the relay 107b, the relay 107d can generate gratuitous ARP packets based on the cached ARP-Reply packets. The relay 107d can generate the gratuitous ARP packets so they appear to be generated by the descendant nodes 107f-107h and 106x-106z. The relay 107d can transmit the gratuitous ARP packets to the AP 104.

When the second relay receives the device information from the first relay, it can update its bridging table based on the received device information and/or propagate the device information to other nodes. For example, with reference to FIG. 5B, when the relay 107b receives a gratuitous ARP packet from the relay 107b, which imitates a gratuitous ARP packet sent by the relay 107f, the relay 107b can update its bridging table with respect to the relay 107f. Accordingly, the relay 107b can learn the correct route to the relay 107d. The relay 107b can forward the gratuitous ARP packet to the AP 104, which can update its bridging table. In an embodiment, the AP 104 can be configured to forward, regenerate, or otherwise propagate the gratuitous ARP packet to the old branch (i.e., to the relay 107a). In an embodiment, the device information and/or gratuitous ARP can be a notification indicative of a change in network topology.

In various embodiments, the first relay can implement a hybrid approach including caching passively monitored ARP packets and sending ARP-Request packets to descendant nodes when cached entries reach an age threshold, or when a cached entry does not exist. For example, the with reference to FIG. 5B, the relay 107d can maintain an ARP cache, such as in the memory 306 (FIG. 3). When the relay 107d attaches to the relay 107b, the relay 107d can determine whether cache entries are older than an age threshold, or do not exist for a particular descendant node. The relay 107d send an ARP-Request packet to each descendant node 107f-107h and 106x-106z for which cache entries are older than the age threshold, or do not exist. The descendant nodes 107f-107h and 106x-106z can respond with an ARP-Reply packet, including node information such as MAC address and/or IP address.

### Re-Configuration of Bridging Table Using Root Node Topology Change

As discussed above, in the section titled “Re-Configuration of Bridging Table Using Gratuitous ARP,” the first relay can transmit an announcement or notification indicating that network topology has changed. In an embodiment, the first relay can transmit the indication that network topology has changed to the root node. For example, the first relay can transmit a topology change notification (TCN) bridge protocol data unit (BPDU) to the root node. In an embodiment, one or more intermediate nodes between the first relay and the root node can forward the TCN BPDU. In various embodiments, the BPDUs discussed herein can be sent and received in accordance with a spanning tree protocol (STP) such as IEEE 802.1d.

The root node can receive the announcement or notification indicating that network topology has changed. For example, the root node can receive a TCN BPDU. The root node can be configured to update its bridging table based on the announcement or notification. In an embodiment, the root node can be configured to transmit a second indication that network topology has changed. For example, the root node can transmit a configuration BPDU (CBPDU) including a topology change (TC) flag to one or more nodes. The TC flag can instruct relay nodes to flush and/or rapidly age entries in their bridging tables. Relay nodes can be configured to propagate the CBPDU including the TC flag.

For example, with respect to FIG. 5B, the relay 107d sends the TCN BPDU to the AP 104 after attaching to the relay 107b. The relay 107b receives the TCN BPDU from the relay 107d, and forwards the TCN BPDU to the AP 104. When the AP 104 receives the TCN BPDU, it transmits one or more CBPDUs including the TC flag. The relays 107a and/or 107b can receive a CBPDU and flush or rapidly age their bridging tables. Accordingly, the relays 107a and/or 107b can relearn the route to the relay 107d.

### Re-Configuration of Bridging Table Using Root-Relay Node Topology Change

In various embodiments, the network can include one or more root-relay nodes. Root relays nodes can include relay nodes attached to the root node. As discussed above, in the section titled “Re-Configuration of Bridging Table Using Gratuitous ARP,” the first relay can transmit an announcement or notification indicating that network topology has changed. In an embodiment, the first relay can transmit the indication that network topology has changed to the closest root-relay node, instead of the root node. For example, the first relay can transmit a topology change notification (TCN) bridge protocol data unit (BPDU) to a root-relay node. In an embodiment, one or more intermediate nodes between the first relay and the root-relay node can forward the TCN BPDU.

The root-relay node can be configured to determine whether it is attached to the root node. For example, the root-relay node can receive a beacon from the root node. The root-relay can determine that the beacon was broadcast by a root node based on the beacon. For example, the beacon can include one or more vendor-specific information elements when the beacon is broadcast by a root node. The root-relay can compare information elements in the beacon with a catalogue of known vendor-specific information elements. When the beacon received from a node includes vendor-specific information elements, the receiving node can determine that it is a root-relay node. In an embodiment, when a receiving node does not identify any vendor-specific information elements in any received beacon, the receiving node can determine that it is not a root-relay node.

For example, with respect to FIG. 5B, the relays 107a and 107b can be referred to as root-relay nodes because they are attached to the AP 104 (i.e., the root node). The AP 104 may transmit a beacon including vendor-specific information elements. For example, the AP 104 may transmit a beacon including a string identifying the name of the manufacturer of the AP 104. The relay 107b can receive the beacon and identify a vendor-specific information element. Accordingly, the relay 107b can determine that it is a root-relay node.

The root-relay node can receive the announcement or notification indicating that network topology has changed. For example, the root-relay node can receive a TCN BPDU. The root-relay node can be configured to update its bridging table based on the announcement or notification. In an embodiment, the root-relay node can be configured to discard the announcement or notification. In other words, the root-relay node can be configured not to forward the announcement or notification to the root node.

In an embodiment, the root-relay node can be configured to transmit a broadcast request. For example, the root-relay node can transmit a ping packet, a discovery packet, and/or a keep-alive packet to one or more nodes. In an embodiment, the root-relay node can transmit the broadcast request only to the new branch. In an embodiment, each node under the root-relay node can reply to the broadcast request, for example, via a ping response, a discovery response, etc. Upon as the reply packets work their way to the root-relay node, each intermediate node can update its bridging table.

For example, with respect to FIG. 5B, the relay 107d sends the TCN BPDU to the AP 104 after attaching to the relay 107b. The relay 107b receives the TCN BPDU from the relay 107d. Because the relay 107b has determined that it is a root-relay node, based on the beacon of the AP 104, the relay 107b does not forward the TCN BPDU to the AP 104. Instead, the relay 107b broadcasts a discovery packet to the nodes in the new branch (i.e., the relays 107d-107h and the STAs 106x-106z). In an embodiment, the relay 107b does not transmit the discovery packet to the relay 107e.

When each node 107d-107h and 106x-106z receives the discovery packet, it sends a discovery response to the root-relay node 107b. For example, the STA 106x can send the discovery response to the root-relay node 107b via the relay 107f and the relay 107d. Accordingly, each intermediate node 107b and 107f updates its bridging table based on the response.

### Disassociation by the Relay Node

In an embodiment, the first relay can disassociate from the old parent node, prior to attaching to a second relay node. For example, the first relay can transmit an announcement including a disassociation notification. In another embodiment, the disassociation notification can be separate from the announcement. When the old parent receives the disassociation notification, it can update its bridging table. For example, the old parent can flush bridging table entries for the first relay and all the nodes under the first relay. In another embodiment, the old parent can flush all bridging entries.

In an embodiment, the old parent can generate and transmit an indication that network topology has changed. For example, the old parent can transmit a TCN BPDU to the root node. In another embodiment, the first relay can transmit an indication that network topology has changed prior to disassociating from the old parent node. For example, the first relay can transmit a TCN BPDU to the root node. As another example, the first relay can transmit a TCN BPDU to the closest root-relay node.

For example, with respect to FIG. 5A, the relay 107d can transmit a disassociation notification to the relay 107a prior to disassociating from the relay 107a. The relay 107a can remove bridging able entries for the nodes 107d, 107f-107h, and 106x-106z. In an embodiment, the relay 107a can generate and transmit a TCN BPDU to the AP 104. In another embodiment, the relay 107d can generate and transmit a TCN BPDU to the relay 107a, acting as a root-relay node. The relay 107d can associate with the relay 107b after disassociating from the relay 107a.

FIG. 7 is a functional block diagram of a wireless device 700, in accordance with an exemplary embodiment of the invention. Those skilled in the art will appreciate that a wireless power apparatus may have more components than the simplified wireless device 700 shown in FIG. 7. The wireless device 700 shown includes only those components useful for describing some prominent features of implementations within the scope of the claims. The wireless device 700 includes means 705 for attaching to a relay node, and means 710 for transmitting an announcement.

In an embodiment, the means 705 for attaching to a relay node can be configured to perform one or more of the functions described above with respect to block 605 (FIG. 6). In various embodiments, the means 705 for attaching to a relay node can be implemented by one or more of the processor 304 (FIG. 3), the memory 306 (FIG. 3), the signal detector 318 (FIG. 3), the transmitter 310 (FIG. 3), the receiver 312 (FIG. 3), the DSP 320 (FIG. 3), and the antenna 316 (FIG. 3).

In an embodiment, the means 710 for transmitting an announcement can be configured to perform one or more of the functions described above with respect to block 610 (FIG. 6). In various embodiments, the means 710 for transmitting an announcement can be implemented by one or more of the processor 304 (FIG. 3), the memory 306 (FIG. 3), the signal detector 318 (FIG. 3), the transmitter 310 (FIG. 3), the receiver 312 (FIG. 3), the DSP 320 (FIG. 3), and the antenna 316 (FIG. 3).

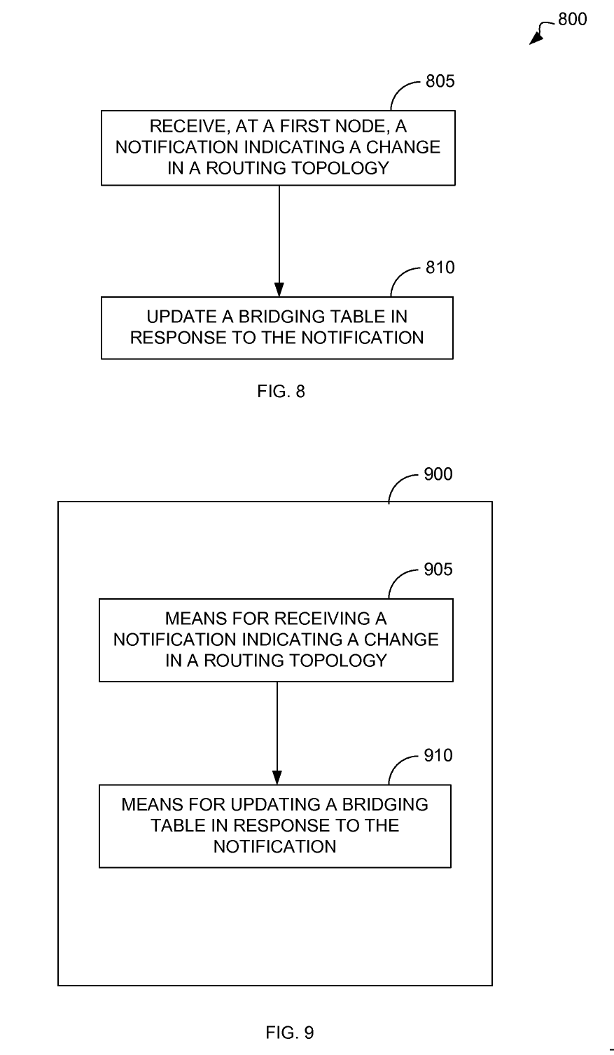

FIG. 8 is a flowchart 800 of another exemplary method of communicating in a multi-hop wireless mesh network. For example, the method of the flowchart 800 can be implemented within the wireless communication system 200, 250, 400, 450, 500, and/or 550, described above with respect to FIGS. 2A, 2B, 4A, 4B, 5A, and 5B, respectively. Particularly, the method of the flowchart 800 can be implemented by one or more of the AP 104 and the relays 107a-h. Although the method of the flowchart 800 is described herein with particular reference to the wireless device 302, discussed above with respect to FIG. 3, a person having ordinary skill in the art will appreciate that the method of flowchart 800 can be implemented by any other suitable device. In an embodiment, the steps in the flowchart 800 can be performed by a processor or controller, such as the processor 304 or the DSP 320 in conjunction with one or more of the memory 306, the transmitter 310, and the receiver 312, described above with respect to FIG. 3. Although the method of the flowchart 800 is described herein with reference to a particular order, in various embodiments, blocks herein can be performed in a different order, or omitted, and additional blocks can be added.

First, at block 805, a first node receives a notification or announcement. In various embodiments, the notification or announcement can include an indication that network topology has changed, a gratuitous ARP, a TCN BPDU, a discovery response packet, etc. The first node can receive the notification from a node attaching to a new branch. The attaching node can have one or more descendant nodes.

For example, as shown in FIG. 5B, the relay 107d can attach to the relay 107b. As discussed above with respect to FIG. 6, the relay 107d can transmit a gratuitous ARP to the relay 107b. The relay 107d can generate the gratuitous ARP so as to appear to be sent from a descendant node. In an embodiment, the relay 107d can transmit a TCN BPDU to the relay 107b. In an embodiment, the relay 107d can transmit a TCN BPDU to the AP 104, via the relay 107b. In various embodiments, the first node can include any of the nodes 104 and 107a-107h, described above with respect to FIG. 5B.

Next, at block 810, the first relay node updates its bridging table in response to the notification or announcement. The notification or announcement can serve to indicate that network topology has changed. In various embodiments, the notification or announcement can include an address resolution protocol (ARP) packet, a topology change notification (TCN) bridge protocol data unit (BPDU), and/or another message indicative of network topology. In response to the announcement, the first relay node can update its bridging table, and/or generate additional messages indicative of network topology.

Referring now to FIG. 5B, as discussed above with respect to the section titled “Re-Configuration of Bridging Table Using Gratuitous ARP,” the relay 107b can receive a gratuitous ARP from the relay 107d for one or more of the descendant nodes 107f-107h and 106x-106z. The relay 107b can update its bridging table accordingly. As discussed above with respect to the section titled “Re-Configuration of Bridging Table Using Root Node Topology Change,” the AP 104 can receive a TCN BPDU, and can transmit one or more CBPDUs including the TC flag. Accordingly, the AP 104 can flush or rapidly age its bridging table in response to the TCN BPDU.

As discussed above with respect to the section titled “Re-Configuration of Bridging Table Using Root-Relay Node Topology Change,” the relay 107b can act as a root-relay node. The relay 107b can receive a TCN BPDU, and can transmit one or more discovery packets to the nodes in the new branch (i.e., the relays 107d-107h and the STAs 106x-106z). The relay 107b can receive one or more discovery responses and thereby updates its bridging table in response to the received TCN BPDU.

In an embodiment, the root-relay can transmit a flush-relay packet. The flush-relay packet can cause one or more nodes to flush their bridging tables. For example, the relay 107b can act as a root relay and transmit a flush-relay packet to the relay 107e. The relay 107e can receive a notification including the flush-relay packet, and flush its bridging table in response to the notification.

FIG. 9 is a functional block diagram of a wireless device 900, in accordance with another exemplary embodiment of the invention. Those skilled in the art will appreciate that a wireless power apparatus may have more components than the simplified wireless device 900 shown in FIG. 9. The wireless device 900 shown includes only those components useful for describing some prominent features of implementations within the scope of the claims. The wireless device 900 includes means 905 for receiving a notification, and means 910 for updating a bridging table in response to the notification.

In an embodiment, the means 905 for receiving a notification can be configured to perform one or more of the functions described above with respect to block 805 (FIG. 8). In various embodiments, the means 905 for receiving a notification can be implemented by one or more of the signal detector 318 (FIG. 3), the receiver 312 (FIG. 3), the DSP 320 (FIG. 3), and the antenna 316 (FIG. 3).

In an embodiment, the means 910 for updating a bridging table in response to the notification can be configured to perform one or more of the functions described above with respect to block 810 (FIG. 8). In various embodiments, the means 910 for updating a bridging table in response to the notification can be implemented by one or more of the processor 304 (FIG. 3), the memory 306 (FIG. 3), the signal detector 318 (FIG. 3), the transmitter 310 (FIG. 3), the receiver 312 (FIG. 3), the DSP 320 (FIG. 3), and the antenna 316 (FIG. 3).

In some embodiments, the old parent node can be configured to discover that a descendant node has disassociated. The old parent node can update its bridging table when it detects that a descendant node has disassociated. In an embodiment, the old parent node can flush bridging table entries related to the disassociated descendant node and nodes under the disassociated descendant node.

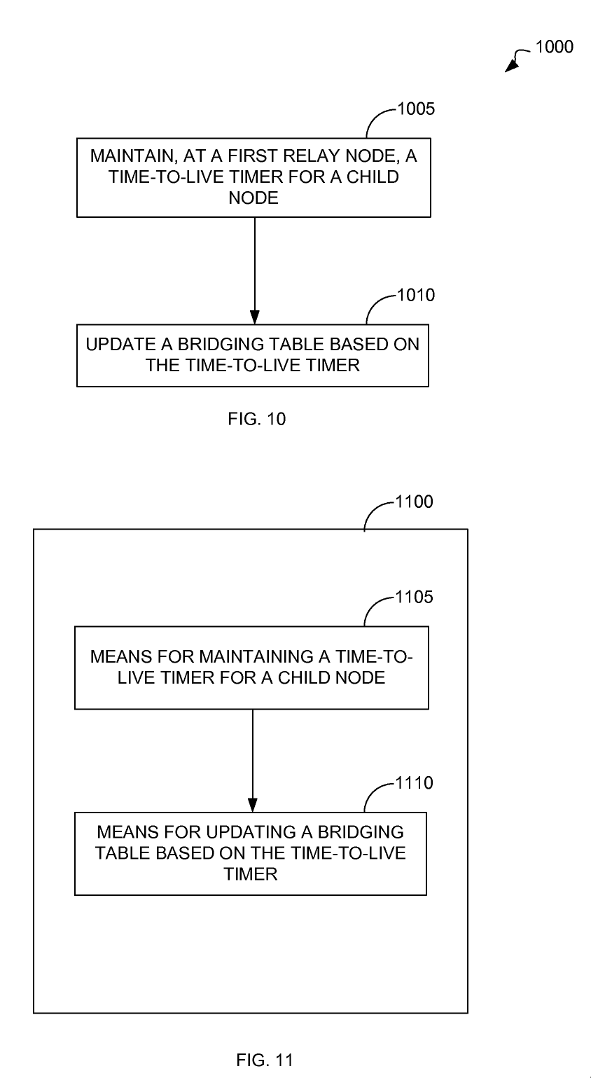

FIG. 10 is a flowchart 1000 of another exemplary method of communicating in a multi-hop wireless mesh network. For example, the method of the flowchart 1000 can be implemented within the wireless communication system 200, 250, 400, 450, 500, and/or 550, described above with respect to FIGS. 2A, 2B, 4A, 4B, 5A, and 5B, respectively. Particularly, the method of the flowchart 1000 can be implemented by one or more of the AP 104 and the relays 107a-h. Although the method of the flowchart 1000 is described herein with particular reference to the wireless device 302, discussed above with respect to FIG. 3, a person having ordinary skill in the art will appreciate that the method of flowchart 1000 can be implemented by any other suitable device. In an embodiment, the steps in the flowchart 1000 can be performed by a processor or controller, such as the processor 304 or the DSP 320 in conjunction with one or more of the memory 306, the transmitter 310, and the receiver 312, described above with respect to FIG. 3. Although the method of the flowchart 1000 is described herein with reference to a particular order, in various embodiments, blocks herein can be performed in a different order, or omitted, and additional blocks can be added.

First, at block 1005, a first relay node maintains a time-to-live timer for a descendant node. The time-to-live timer can serve to alert the first relay when it has not received traffic from the descendant node in a threshold amount of time. The timer can be preset or dynamically adjusted. The timer can be stored in the bridging table, for example, in the memory 306 (FIG. 3). In an embodiment, the timer can be decremented periodically or intermittently such as, for example, once a millisecond. A person having ordinary skill in the art will appreciate that the timer can instead be incremented or otherwise adjusted, to track an inactivity timeout of the descendant node.

In an embodiment, first relay node can receive packets from the descendant node. The first relay node can reset the time-to-live timer when a packet is received from the descendant node. For example, the time-to-live timer can be reset to an original threshold timeout value. When the time-to-live timer reaches zero, the first relay node can determine that the descendant node has disassociated.

In an embodiment, when the time-to-live timer reaches zero, the first relay node may not immediately determine that the descendant node has disassociated. Instead, the first relay node can transmit a request packet to the descendant node. The request packet can have a destination address set to a broadcast address. The request packet can include one or more of a ping packet, keep-alive packet, and/or discovery request. The first relay node can track a timeout for the request packet. When the request packet times out without a response, the first relay node can determine that the descendant node has disassociated.

In an embodiment, when the request packet times out without a response, the first relay node may not immediately determine that the descendant node has disassociated. Instead, the first relay node can transmit additional request packets to the descendant node. The first relay node can transmit up to a first threshold of request packets to the descendant node before determining that the descendant node has disassociated. The first threshold can be preset or dynamically determined. When the threshold number of request packets have timed out, the first relay node can determine that the descendant node has disassociated.

For example, with respect to FIG. 5A, the relay 107a can maintain a time-to-live entry in its bridging table for the relay 107d. Whenever the relay 107d transmits information to the relay 107a, the relay 107a can reset the timer. Referring now to FIG. 5B, the relay 107d can disassociate from the relay 107a without notifying the relay 107a. After the time-to-live timer expires, the relay 107a can attempt to transmit a ping packet to the relay 107d. When the ping packet times out, the relay 107a can attempt to transmit additional ping packets. After the threshold number of attempts has been reached, the relay 107a can determine that the relay 107d has disassociated.

Next, at block 1010, a first relay node updates its bridging table based on the time-to-live timer. For example, after the first relay node determines that the descendant node has disassociated (due to timer expiration, request packet timeout, a retry threshold being reached, etc.), the first relay node can flush bridging table entries for the descendant node. The first relay node can also flush bridging table entries for nodes below the descendant node. In an embodiment, the first relay node can transmit an indication that network topology has changed. For example, the first relay node can transmit a TCN BPDU to the root node.

For example, referring to FIG. 5B, the relay node 107a can flush its bridging table entries for the relays 107d and 107f-107h, and the STAs 106x-106z. The relay node 107a can also transmit a TCN BPDU to the AP 104. In an embodiment, the relay node 107a can act as a root-relay, and can receive a TCN BPDU from another node.

FIG. 11 is a functional block diagram of a wireless device 1100, in accordance with another exemplary embodiment of the invention. Those skilled in the art will appreciate that a wireless power apparatus may have more components than the simplified wireless device 1100 shown in FIG. 11. The wireless device 1100 shown includes only those components useful for describing some prominent features of implementations within the scope of the claims. The wireless device 1100 includes means 1105 for maintaining a time-to-live timer for a descendant node, and means 1110 for updating a bridging table based on the time-to-live timer.

In an embodiment, the means 1105 for maintaining a time-to-live timer for a descendant node can be configured to perform one or more of the functions described above with respect to block 1005 (FIG. 10). In various embodiments, the means 1105 for maintaining a time-to-live timer for a descendant node can be implemented by one or more of the processor 304 (FIG. 3), the memory 306 (FIG. 3), the signal detector 318 (FIG. 3), the transmitter 310 (FIG. 3), the receiver 312 (FIG. 3), the DSP 320 (FIG. 3), and the antenna 316 (FIG. 3).

In an embodiment, the means 1110 for updating a bridging table based on the time-to-live timer can be configured to perform one or more of the functions described above with respect to block 1010 (FIG. 10). In various embodiments, the means 1110 for updating a bridging table based on the time-to-live timer can be implemented by one or more of the processor 304 (FIG. 3), the memory 306 (FIG. 3), and the DSP 320 (FIG. 3).

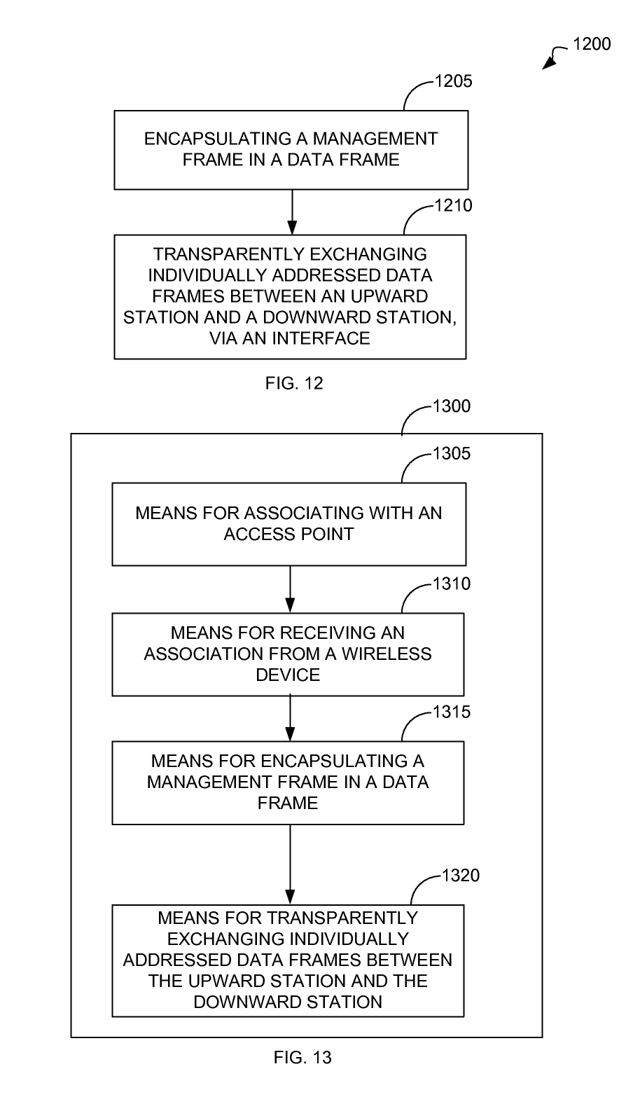

FIG. 12 is a flowchart 1200 of an exemplary method of communicating in the relay device 107 of FIG. 4C. The method of the flowchart 1200 can be implemented, for example, within the wireless communication system 200, 250, 400, 450, 500, and/or 550, described above with respect to FIGS. 2A, 2B, 4A, 4B, 5A, and 5B, respectively. Particularly, the method of the flowchart 1200 can be implemented by one or more of the relay device 107a-107c. Although the method of the flowchart 1200 is described herein with particular reference to the wireless device 302, discussed above with respect to FIG. 3, and the relay device 107, discussed above with respect to FIG. 4C, a person having ordinary skill in the art will appreciate that the method of flowchart 1200 can be implemented by any other suitable device. In an embodiment, the steps in the flowchart 1200 can be performed by a processor or controller, such as the processor 304 or the DSP 320 in conjunction with one or more of the memory 306, the transmitter 310, and the receiver 312, described above with respect to FIG. 3. Although the method of the flowchart 1200 is described herein with reference to a particular order, in various embodiments, blocks herein can be performed in a different order, or omitted, and additional blocks can be added.

First, at block 1205, the processor 304 encapsulates a management frame in a data frame. In an embodiment, the data frame carrying the encapsulated management frames can include an action frames having an ethertype set to 89-0D. In an embodiment, the management frame can include a reachable address message. In an embodiment, the management frame can include an indication from a U-STA 405 to a D-STA 410 that the U-STA 405 has associated with an access point. In an embodiment, the management frame can include an indication from the downward station to the U-STA 405 that a wireless device has associated with the D-STA 410.

Next, at block, 1210, the UDI 455 transparently exchanges individually addressed data frames between the U-STA 405 and the D-STA 410. In an embodiment, the UDI 455 can include an 802.1D bridge. In an embodiment, the 802.1D bridge can include exactly two ports. In an embodiment, the U-STA 405 can be configured to send frames that have an A3 address different from an address of the U-STA 405 to the D-STA 410 via the UDI 455. In an embodiment the D-STA 410 is configured to send media access control (MAC) service data unit (MSDU) frames, received from associated wireless devices, to the U-STA 405 via the UDI 455.

FIG. 13 is a functional block diagram of a relay device 1300, in accordance with another exemplary embodiment of the invention. Those skilled in the art will appreciate that a wireless power apparatus may have more components than the simplified relay device 1300 shown in FIG. 13. The relay device 1300 shown includes only those components useful for describing some prominent features of implementations within the scope of the claims. The relay device 1300 includes means 1305 for associating with an access point, means 1310 for receiving an association from a wireless device, means 1315 for encapsulating a management frame in a data frame, and means 1320 for transparently exchanging individually addressed data frames between the upward station and the downward station.

In an embodiment, the means 1305 for associating with an access point can be configured to perform one or more of the functions described above with respect to the U-STA 405b, 405c, 405rx, and/or 405tx. In various embodiments, the means 1305 for associating with an access point can be implemented by one or more of the processor 304 (FIG. 3), the memory 306 (FIG. 3), the signal detector 318 (FIG. 3), the transmitter 310 (FIG. 3), the receiver 312 (FIG. 3), the DSP 320 (FIG. 3), and the antenna 316 (FIG. 3).

In an embodiment, the means 1310 for receiving an association from a wireless device can be configured to perform one or more of the functions described above with respect to the U-STA 410b, 410c, 410rx, and/or 410tx. In various embodiments, the means 1310 for receiving an association from a wireless device can be implemented by one or more of the processor 304 (FIG. 3), the memory 306 (FIG. 3), the signal detector 318 (FIG. 3), the transmitter 310 (FIG. 3), the receiver 312 (FIG. 3), the DSP 320 (FIG. 3), and the antenna 316 (FIG. 3).

In an embodiment, the means 1315 for encapsulating a management frame in a data frame can be configured to perform one or more of the functions described above with respect to block 1205 (FIG. 12). In various embodiments, the means 1315 for encapsulating a management frame in a data frame can be implemented by one or more of the processor 304 (FIG. 3), the memory 306 (FIG. 3), and the DSP 320 (FIG. 3).

In an embodiment, the means 1320 for transparently exchanging individually addressed data frames between the upward station and the downward station can be configured to perform one or more of the functions described above with respect to the block 1210 (FIG. 12). In various embodiments, the means 1320 for transparently exchanging individually addressed data frames between the upward station and the downward station can be implemented by one or more of the processor 304 (FIG. 3), the memory 306 (FIG. 3), and the DSP 320 (FIG. 3).

As used herein, the term “determining” encompasses a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like. Further, a “channel width” as used herein can encompass or can also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can include non-transitory computer readable medium (e.g., tangible media). In addition, in some aspects computer readable medium can include transitory computer readable medium (e.g., a signal). Combinations of the above should also be included within the scope of computer-readable media.

The methods disclosed herein include one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

The functions described can be implemented in hardware, software, firmware or any combination thereof. If implemented in software, the functions can be stored as one or more instructions on a computer-readable medium. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects can include a computer program product for performing the operations presented herein. For example, such a computer program product can include a computer readable medium having instructions stored (and/or encoded) thereon, the instructions being executable by one or more processors to perform the operations described herein. For certain aspects, the computer program product can include packaging material.

Software or instructions can also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations can be made in the arrangement, operation and details of the methods and apparatus described above without departing from the scope of the claims.

While the foregoing is directed to aspects of the present disclosure, other and further aspects of the disclosure can be devised without departing from the basic scope thereof, and the scope thereof is determined by the claims that follow.

What is claimed is:

1. A method of communicating in a multi-hop wireless mesh network comprising a root node and a plurality of relay nodes, the method comprising:
attaching a first relay node to a second relay node, the first relay node having one or more descendant nodes;
transmitting an announcement configured to initiate a modification of a bridging table with respect to the attached first relay node and its descendant nodes;
maintaining, at the first relay node, a time-to-live timer for a descendant node; and
updating a bridging table based on the time-to-live timer.

2. The method of claim 1, further comprising:
determining device information for each of the descendant nodes,
wherein transmitting the announcement comprises transmitting to the root node, for each descendant node, an announcement comprising the device information.

3. The method of claim 2, wherein the announcement comprises a gratuitous address resolution protocol (ARP) packet.

4. The method of claim 2, wherein determining the device information for each of the descendant nodes comprises:
sending a request for device information to each descendant node; and
caching a response from each descendant node, the response comprising the device information.

5. The method of claim 4, wherein:
the request for device information comprises an address resolution protocol (ARP)-Request packet,
the response from each descendant node comprises an ARP-Reply packet, and
the announcement comprises a gratuitous ARP packet.

6. The method of claim 2, wherein determining the device information for each of the descendant nodes comprises:
monitoring device information sent by each descendant node; and
caching the monitored device information for each descendant node.

7. The method of claim 6, wherein:
the monitored device information comprises one or more address resolution protocol (ARP) packet, and
the announcement comprises a gratuitous ARP packet.

8. The method of claim 4, further comprising:
associating a cache timer with each descendant node;
sending the request for device information to a descendant node, and relaying the response to the root node, when a packet has not been received from the descendant node before the associated timer expires; and
transmitting cached device information to the root node when a packet has been received from the descendant nodes before the associated timer expires.

9. The method of claim 1, wherein transmitting the announcement comprises transmitting, to the root node, an indication that network topology has changed.

10. The method of claim 9, wherein the indication that network topology has changed comprises a topology change notification (TCN) bridge protocol data unit (BPDU).

11. The method of claim 1, wherein:
the wireless communications network further comprises a root relay attached to the root node, and
transmitting the announcement comprises transmitting, to the root relay, an indication that network topology has changed.

12. The method of claim 11, wherein the announcement comprises a topology change notification (TCN) bridge protocol data unit (BPDU).

13. The method of claim 1, further comprising disassociating, from a third relay node, prior to attaching to a second relay node.

14. The method of claim 1, wherein the announcement comprises a link-layer update frame addressed to the root node, comprising media access control (MAC) address of all descendant nodes under the first relay, the link-layer update frame configured to cause each of the relay nodes, in the path between the first relay and the root node, to update a bridging entry.

15. The method of claim 1, further comprising resetting the time-to-live timer when a packet is received from the descendant node.

16. The method of claim 15, further comprising transmitting a request packet to the descendant node when the time-to-live timer expires.

17. The method of claim 16, wherein the request packet comprises a least one of a ping packet, a discovery packet, and a keep-alive packet.

18. The method of claim 16, further comprising retransmitting the request packet when a packet is not received from the descendant node within a request timeout.

19. The method of claim 18, further comprising flushing entries for the descendant node, and nodes below the descendant node, when a packet is not received from the descendant node within one of the time-to-live timer, the request timeout, and a retry threshold.

20. A device configured to communicate in a multi-hop wireless mesh network comprising a root node and a plurality of relay nodes, the device having one or more descendant nodes, comprising:
a processor configured to:
maintain a time-to-live timer for a descendant node;
update a bridging table based on the time-to-live timer; and
attach the device to a relay node; and
a transmitter configured to transmit an announcement configured to initiate a modification of a bridging table with respect to the device and its descendant nodes.

21. The device of claim 20, wherein:
the processor is further configured to determine device information for each of the descendant nodes, and
the transmitter is further configured to transmit, to the root node, for each descendant node, an announcement comprising the device information.

22. The device of claim 21, wherein the announcement comprises a gratuitous address resolution protocol (ARP) packet.

23. The device of claim 21, wherein determining the device information for each of the descendant nodes comprises:
sending a request for device information to each descendant node; and
caching a response from each descendant node, the response comprising the device information.

24. The device of claim 23, wherein:
the request for device information comprises an address resolution protocol (ARP)-Request packet,
the response from each descendant node comprises an ARP-Reply packet, and
the announcement comprises a gratuitous ARP packet.

25. The device of claim 21, wherein determining the device information for each of the descendant nodes comprises:
monitoring device information sent by each descendant node; and
caching the monitored device information for each descendant node.

26. The device of claim 25, wherein:
the monitored device information comprises one or more address resolution protocol (ARP) packet, and
the announcement comprises a gratuitous ARP packet.

27. The device of claim 23, wherein:
the processor is further configured to associate a cache timer with each descendant node; and
the transmitter is further configured to:
send the request for device information to a descendant node, and relay the response to the root node, when a packet has not been received from the descendant node before the associated timer expires; and
transmit cached device information to the root node when a packet has been received from the descendant nodes before the associated timer expires.

28. The device of claim 20, wherein the transmitter is further configured to transmit, to the root node, an indication that network topology has changed.

29. The device of claim 28, wherein the indication that network topology has changed comprises a topology change notification (TCN) bridge protocol data unit (BPDU).

30. The device of claim 20, wherein:
the wireless communications network further comprises a root relay attached to the root node, and
the transmitter is further configured to transmit, to the root relay, an indication that network topology has changed.

31. The device of claim 30, wherein the announcement comprises a topology change notification (TCN) bridge protocol data unit (BPDU).

32. The device of claim 20, wherein the processor is further configured to disassociate the device, from a second relay node, prior to attaching to a relay node.

33. The device of claim 20, wherein the announcement comprises a link-layer update frame addressed to the root node, comprising media access control (MAC) address of all descendant nodes under the first relay, the link-layer update frame configured to cause each of the relay nodes, in the path between the first relay and the root node, to update a bridging entry.

34. The device of claim 20, wherein the processor is further configured to reset the time-to-live timer when a packet is received from the descendant node.

35. The device of claim 34, wherein the transmitter is configured to transmit a request packet to the descendant node when the time-to-live timer expires.

36. The device of claim 35, wherein the request packet comprises a least one of a ping packet, a discovery packet, and a keep-alive packet.

37. The device of claim 35, wherein the transmitter is further configured to retransmit the request packet when a packet is not received from the descendant node within a request timeout.

38. The device of claim 37, wherein the processor is further configured to flush entries for the descendant node, and nodes below the descendant node, when a packet is not received from the descendant node within one of the time-to-live timer, the request timeout, and a retry threshold.

39. An apparatus for communicating in a multi-hop wireless mesh network comprising a root node and a plurality of relay nodes, the apparatus comprising:
means for attaching a first relay node to a second relay node, the first relay node having one or more descendant nodes;
means for transmitting an announcement configured to initiate a modification of a bridging table with respect to the attached first relay node and its descendant nodes;
means for maintaining, at the first relay node, a time-to-live timer for a descendant node; and
means for updating a bridging table based on the time-to-live timer.

40. The apparatus of claim 39, further comprising:
means for determining device information for each of the descendant nodes,
wherein means for transmitting the announcement comprises means for transmitting to the root node, for each descendant node, an announcement comprising the device information.

41. The apparatus of claim 40, wherein the announcement comprises a gratuitous address resolution protocol (ARP) packet.

42. The apparatus of claim 40, wherein means for determining the device information for each of the descendant nodes comprises:
means for sending a request for device information to each descendant node; and
means for caching a response from each descendant node, the response comprising the device information.

43. The apparatus of claim 42, wherein:
the request for device information comprises an address resolution protocol (ARP)-Request packet,
the response from each descendant node comprises an ARP-Reply packet, and
the announcement comprises a gratuitous ARP packet.

44. The apparatus of claim 40, wherein means for determining the device information for each of the descendant nodes comprises:
means for monitoring device information sent by each descendant node; and
means for caching the monitored device information for each descendant node.

45. The apparatus of claim 44, wherein:
the monitored device information comprises one or more address resolution protocol (ARP) packet, and
the announcement comprises a gratuitous ARP packet.

46. The apparatus of claim 42, further comprising:
means for associating a cache timer with each descendant node;
means for sending the request for device information to a descendant node, and means for relaying the response to the root node, when a packet has not been received from the descendant node before the associated timer expires; and
means for transmitting cached device information to the root node when a packet has been received from the descendant nodes before the associated timer expires.

47. The apparatus of claim 39, wherein means for transmitting the announcement comprises means for transmitting, to the root node, an indication that network topology has changed.

48. The apparatus of claim 47, wherein the indication that network topology has changed comprises a topology change notification (TCN) bridge protocol data unit (BPDU).

49. The apparatus of claim 39, wherein:
the wireless communications network further comprises a root relay attached to the root node, and
means for transmitting the announcement comprises means for transmitting, to the root relay, an indication that network topology has changed.

50. The apparatus of claim 49, wherein the announcement comprises a topology change notification (TCN) bridge protocol data unit (BPDU).

51. The apparatus of claim 39, further comprising means for disassociating, from a third relay node, prior to attaching to a second relay node.

52. The apparatus of claim 39, wherein the announcement comprises a link-layer update frame addressed to the root node, comprising media access control (MAC) address of all descendant nodes under the first relay, the link-layer update frame configured to cause each of the relay nodes, in the path between the first relay and the root node, to update a bridging entry.

53. The apparatus of claim 39, further comprising means for resetting the time-to-live timer when a packet is received from the descendant node.

54. The apparatus of claim 53, further comprising means for transmitting a request packet to the descendant node when the time-to-live timer expires.

55. The apparatus of claim 54, wherein the request packet comprises a least one of a ping packet, a discovery packet, and a keep-alive packet.

56. The apparatus of claim 54, further comprising means for retransmitting the request packet when a packet is not received from the descendant node within a request timeout.

57. The apparatus of claim 56, further comprising means for flushing entries for the descendant node, and nodes below the descendant node, when a packet is not received from the descendant node within one of the time-to-live timer, the request timeout, and a retry threshold.

58. A non-transitory computer-readable medium comprising code that, when executed, causes an apparatus to:
attach a first relay node to a second relay node in a multi-hop wireless mesh network comprising a root node and a plurality of relay nodes, the first relay node having one or more descendant nodes;
transmit an announcement configured to initiate a modification of a bridging table with respect to the attached first relay node and its descendant nodes;
maintain, at the first relay node in a multi-hop wireless mesh network comprising a root node and a plurality of relay nodes, a time-to-live timer for a descendant node; and
update a bridging table based on the time-to-live timer.

59. The medium of claim 58, further comprising code that, when executed, causes the apparatus to:
determine device information for each of the descendant nodes,
wherein transmitting the announcement comprises transmitting to the root node, for each descendant node, an announcement comprising the device information.

60. The medium of claim 59, wherein the announcement comprises a gratuitous address resolution protocol (ARP) packet.

61. The medium of claim 59, wherein determining the device information for each of the descendant nodes comprises:
sending a request for device information to each descendant node; and
caching a response from each descendant node, the response comprising the device information.

62. The medium of claim 61, wherein:
the request for device information comprises an address resolution protocol (ARP)-Request packet,
the response from each descendant node comprises an ARP-Reply packet, and
the announcement comprises a gratuitous ARP packet.

63. The medium of claim 59, wherein determining the device information for each of the descendant nodes comprises:
monitoring device information sent by each descendant node; and
caching the monitored device information for each descendant node.

64. The medium of claim 63, wherein:
the monitored device information comprises one or more address resolution protocol (ARP) packet, and
the announcement comprises a gratuitous ARP packet.

65. The medium of claim 61, further comprising code that, when executed, causes the apparatus to:
associate a cache timer with each descendant node;
send the request for device information to a descendant node, and relay the response to the root node, when a packet has not been received from the descendant node before the associated timer expires; and
transmit cached device information to the root node when a packet has been received from the descendant nodes before the associated timer expires.

66. The medium of claim 58, wherein transmitting the announcement comprises transmitting, to the root node, an indication that network topology has changed.

67. The medium of claim 66, wherein the indication that network topology has changed comprises a topology change notification (TCN) bridge protocol data unit (BPDU).

68. The medium of claim 58, wherein:
the wireless communications network further comprises a root relay attached to the root node, and
transmitting the announcement comprises transmitting, to the root relay, an indication that network topology has changed.

69. The medium of claim 68, wherein the announcement comprises a topology change notification (TCN) bridge protocol data unit (BPDU).

70. The medium of claim 58, further comprising disassociating, from a third relay node, prior to attaching to a second relay node.

71. The medium of claim 58, wherein the announcement comprises a link-layer update frame addressed to the root node, comprising media access control (MAC) address of all descendant nodes under the first relay, the link-layer update frame configured to cause each of the relay nodes, in the path between the first relay and the root node, to update a bridging entry.

72. The medium of claim, 58, further comprising code that, when executed, causes the apparatus to transmit a request packet to the descendant node when the time-to-live timer expires.

73. The medium of claim 72, wherein the request packet comprises a least one of a ping packet, a discovery packet, and a keep-alive packet.

74. The medium of claim 72, further comprising code that, when executed, causes the apparatus to retransmit the request packet when a packet is not received from the descendant node within a request timeout.

75. The medium of claim 74, further comprising code that, when executed, causes the apparatus to flush entries for the descendant node, and nodes below the descendant node, when a packet is not received from the descendant node within one of the time-to-live timer, the request timeout, and a retry threshold.
